(19) United States
(12) Patent Application Publication
(10) Pub. No.: US 2009/0231269 A1
(43) Pub. Date: Sep. 17, 2009

(54) INPUT DEVICE, SIMULATED EXPERIENCE METHOD AND ENTERTAINMENT SYSTEM

(76) Inventors: Hiromu Ueshima, Shiga (JP); Keiichi Yasumura, Shiga (JP); Hiroyuki Aimoto, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/917,208

(22) PCT Filed: Jun. 13, 2006
(86) PCT No.: PCT/JP2006/312212

§ 371 Date: Dec. 12, 2007

(30) Foreign Application Priority Data
Jun. 16, 2005 (JP) 2005-175987
Jul. 11, 2005 (JP) 2005-201360
Nov. 9, 2005 (JP) 2005-324699

(51) Int. Cl. G09G 5/00

(52) U.S. Cl. 345/156

(57) ABSTRACT

A retroreflective sheet 32 is provided on the inner surface of a transparent member 44. A belt 40 is attached to the transparent member 44 along the bottom surface thereof in the form of an annular member. An operator inserts middle and annular fingers into the belt 40 in order that the transparent member 44 is located on the palm of the hand. The information processing apparatus 1 can determine an input operation when a hand is opened so that the image of the retroreflective sheet 32 is captured, and determine a non-input operation when a hand is closed so that the image of the retroreflective sheet 32 is not captured.

### TECHNICAL FIELD

The present invention relates to an input device provided with a reflecting member serving as a subject, and the related arts.

### BACKGROUND ART

Japanese Patent Published Application No. 2004-85524 by the present applicant discloses a golf game system including a game apparatus and golf-club-type input device, and the housing of the game apparatus houses an imaging unit which comprises an image sensor, infrared light emitting diodes and so forth. The infrared light emitting diodes intermittently emit infrared light to a predetermined area in front of the imaging unit while the image sensor intermittently captures an image of the reflecting member of the golf-club-type input device which is moving in the predetermined area. The velocity and the like of the input device can be calculated as the inputs given to the game apparatus by processing the stroboscopic images of the reflecting member. In this manner, it is possible to provide a computer or a game apparatus with inputs on a real time base by the use of a stroboscope.

It is therefore an object of the present invention to provide an input device and the related arts provided with a reflecting member serving as a subject, and capable of giving an input to an information processing apparatus on a real time base and easily performing the control of the input/no-input states.

It is another object of the present invention to provide a simulated experience method and the related arts in which it is possible to enjoy experiences, which cannot be experienced in the actual world, through the actions in the actual world and through the images displayed on a display device.

It is a further object of the present invention to provide an entertainment system in which it is possible to enjoy simulated experience of performance of a character in an imaginary world.

### DISCLOSURE OF INVENTION

In accordance with a first aspect of the present invention, an input device serving as a subject of imaging and operable to give an input to an information processing apparatus which performs a process in accordance with a program, comprises: a first reflecting member operable to reflect light which is directed to the first reflecting member; and a wear member operable to be worn on a hand of an operator and attached to said first mount member.

In accordance with this configuration, since the operator can manipulate the input device by wearing it on the hand, it is possible to easily perform the control of the input/no-input states detectable by the information processing apparatus.

In this input device, said wear member is configured to allow an operator to wear a hand thereinto in order that said first reflecting member is located on the palm side of the hand.

In accordance with this configuration, the operator can easily perform the control of the input/no-input states detectable by the information processing apparatus only by wearing the input device and opening or closing the hand. In other words, the information processing apparatus can determine an input operation when a hand is opened so that the image of the first reflecting member is captured, and determine a non-input operation when a hand is closed so that the image of the first reflecting member is not captured.

In this case, said first reflecting member is covered by a transparent member (inclusive of a semi-transparent or a colored-transparent material). In accordance with this configuration, the first reflecting member does not come in direct contact with the hand of the operator so that the durability of the first reflecting member can be improved.

On the other hand, in the input device as described above, said wear member is configured to allow an operator to wear it on a hand in order that said first reflecting member is located on the back side of the operator's hand. In accordance with this configuration, the operator can easily perform the control of the input/no-input states detectable by the information processing apparatus while closing the fist. In this case, the reflecting surface of said first reflecting member is formed in order to face the operator when the operator wears said input device on the hand.

In accordance with this configuration, since the reflecting surface of the first reflecting member is put on the back side of the operator's hand and oriented to face the operator, the image thereof is not captured unless the operator intentionally moves the reflecting surface to face the information processing apparatus. Accordingly, an incorrect input operation can be avoided.

The input device as described above comprises: a second reflecting member operable to reflect light which is directed to said second reflecting member, wherein said second reflecting member is attached to said wear member in order that said second reflecting member is opposed to said first reflecting member, wherein said wear member is configured to allow the operator to wear a hand thereinto in order that said first reflecting member is located on the palm side of the hand and that said second reflecting member is located on the back side of the operator's hand.

In accordance with this configuration, since the first reflecting object and the second reflecting object are put respectively on the palm side of the hand and the back side of the operator's hand, it is possible to perform the control of the input/no-input states detectable by the information processing apparatus by opening or closing the hand, and it is also possible to perform the control of the input/no-input states detectable by the information processing apparatus while closing the fist. In this case, the reflecting surface of said second reflecting member is formed in order to face the operator when the operator wears said input device on the hand.

In accordance with this configuration, since the reflecting surface of the second reflecting member is put on the back side of the operator's hand and oriented to face the operator, the image thereof is not captured unless the operator intentionally moves the reflecting surface to face the information processing apparatus. Accordingly, when the operator performs an input/no-input operation by the use of the first reflecting member, no image of the second reflecting member is captured so that an incorrect input operation can be avoided.

In the input device as described above, said wear member is an bandlike member. In accordance with this configuration, the operator can easily wear the input device on a hand.

In accordance with a second aspect of the present invention, an input device serving as a subject of imaging and operable to give an input to an information processing apparatus which performs a process in accordance with a program, comprises: a first reflecting member operable to reflect light which is directed to the first reflecting member; a first mount member having a plurality of sides inclusive of a bottom side- and provided with said first reflecting member attached to at least one of the sides which is not the bottom side; and a bandlike member in the form of an annular member attached to said first mount member along the bottom side, wherein said bandlike member is configured to allow an operator to insert a finger thereinto.

In accordance with this configuration, since the operator can manipulate the input device by wearing it on the figure, it is possible to easily perform the control of the input/no-input states detectable by the information processing apparatus. The bandlike member of this input device is configured to allow the operator to insert a finger thereinto in order that said first mount member is located on the palm of the hand.

In accordance with this configuration, the operator can easily perform the control of the input/no-input states detectable by the information processing apparatus only by wearing the input device and opening or closing the hand. In other words, the information processing apparatus can determine an input operation when a hand is opened so that the image of the first reflecting member is captured, and determine a non-input operation when a hand is closed so that the image of the first reflecting member is not captured.

Furthermore, in this input device, said first reflecting member is attached to the inner surface of the side which is not the bottom side of said first mount member, wherein said first mount member is made of a transparent color material (inclusive of a semi-transparent or a colored-transparent material) at least from the inner surface to which said first reflecting member is attached through the outer surface of the side.

In accordance with this configuration, the first reflecting member does not come in direct contact with the hand of the operator so that the durability of the first reflecting member can be improved.

On the other hand, said bandlike member of the above input device may be configured to allow the operator to insert the finger thereinto in order that said first mount member is located on the back face of the finger of the operator. In accordance with this configuration, the operator can easily perform the control of the input/no-input states detectable by the information processing apparatus while closing the fist. In this case, the side to which the first reflecting member is attached is located in order to face the operator when the operator inserts the finger into the annular member.

In accordance with this configuration, since the first reflecting member is put on the back face of the finger of the operator and oriented to face the operator, the image thereof is not captured unless the operator intentionally moves the first reflecting member to face the information processing apparatus. Accordingly, an incorrect input operation can be avoided.

The above input device further comprises: a second reflecting member operable to reflect light which is directed to said second reflecting member; and a second mount member having a plurality of sides inclusive of a bottom side and provided with said second reflecting member attached to at least one of the sides which is not the bottom side, wherein said bandlike member is attached to said first mount member and said second mount member along the bottom sides thereof in order that the bottom sides are opposed to each other, wherein said bandlike member is configured to allow the operator to insert the finger thereinto in order that said first mount member is located on the palm of the hand and that said second mount member is located on the back face of the finger of the operator.

In accordance with this configuration, since the first reflecting object and the second reflecting object are put respectively on the palm of the hand and the back face of the finger, it is possible to perform the control of the input/no-input states detectable by the information processing apparatus by opening or closing the hand, and it is also possible to perform the control of the input/no-input states detectable by the information processing apparatus while closing the fist. In this input device, the side to which the second reflecting member is attached is located in order to face the operator when the operator inserts the finger into the bandlike member.

In accordance with this configuration, since the second reflecting member is put on the back face of the finger of the operator and oriented to face the operator, the image thereof is not captured unless the operator intentionally moves the second reflecting member to face the information processing apparatus. Accordingly, when the operator performs an input/no-input operation by the use of the first reflecting member, no image of the second reflecting member is captured so that an incorrect input operation can be avoided.

In accordance with a third aspect of the present invention, a simulated experience method of detecting two operation articles to which motions are imparted respectively with the left and right hands of an operator and displaying a predetermined image on the display device on the basis of the detection result, comprises: capturing an image of the operation articles provided with reflecting members; determining whether or not at least a first condition and a second condition are satisfied by the image which is obtained by the image capturing; and displaying the predetermined image if the first condition and the second condition are satisfied at least, wherein the first condition is that the image which is obtained by the image capturing includes neither of the two operation articles, wherein the second condition is that the image obtained by the image capturing includes an image of at least one of the operation articles after the first condition is satisfied.

In accordance with this configuration, the operator can enjoy experiences, which cannot be experienced in the actual world, through the actions in the actual world (the operations of the operation article) and through the images displayed on the display device.

In this simulated experience method, the second condition can be set such that the image obtained by the image capturing includes the two operation articles after the first condition is satisfied. Also, the second condition can be set such that the image obtained by the image capturing includes the two operation articles in predetermined arrangement after the first condition is satisfied.

In the step of the above simulated experience method in which the predetermined image is displayed, the predetermined image is displayed when a third condition and a fourth condition are satisfied as well as the first condition and the second condition, wherein the third condition is that the image captured by the image capturing includes neither of the two operation articles after the second condition is satisfied, and wherein the fourth condition is that the image captured by the image capturing includes at least one of the operation articles after the third condition is satisfied.

In accordance with a fourth aspect of the present invention, an entertainment system that makes it possible to enjoy simulated experience of performance of a character in an imaginary world, comprises: a pair of operation articles to be worn on both hands of a operator when the operator is enjoying said entertainment system; an imaging device operable to capture images of said operation articles; a processor connected to said imaging device, and operable to receive the images of said operation articles from said imaging device and determine the positions of said operation articles on the basis of the images of said operation articles; and a storing unit for storing a plurality of motion patterns which represent motions of said operation articles respectively corresponding to predetermined actions of the character, and action images which show phenomena caused by the predetermined actions of the character, wherein when the operator wears said operation articles on the hands and performs one of the predetermined actions of the character, said processor determines which of the motion patterns corresponds to the predetermined action performed by the operator on the basis of the positions of said operation articles, and generates the video signal for displaying the action image corresponding to the motion pattern as determined.

In accordance with this configuration, the operator can enjoy simulated experience of performance of a character in an imaginary world. In this case, the above character is not a character which is displayed in the virtual space on the display device in accordance with the video signal as generated, but a character in the imaginary world which is a model of the virtual space.

### BRIEF DESCRIPTION OF DRAWINGS

The novel features of the invention are set forth in the appended claims. The invention itself, however, as well as other features and advantages thereof, will be best understood by reading the detailed description of specific embodiments in conjunction with the accompanying drawings, wherein:

FIG. 1 is a block diagram showings the entire configuration of an information processing system in accordance with an embodiment of the present invention.

FIG. 2A and FIG. 2B are perspective views for showing the input device 3L (3R) of FIG. 1.

FIG. 3A is an explanatory view for showing an exemplary usage of the input device 3L (3R) of FIG. 1.

FIG. 3B is an explanatory view for showing another exemplary usage of the input device 3L (3R) of FIG. 1.

FIG. 3C is an explanatory view for showing a further exemplary usage of the input device 3L (3R) of FIG. 1.

FIG. 4 is a view showing the electric configuration of the information processing apparatus 1 of FIG. 1.

FIG. 5 is a view for showing an example of a game screen as displayed on the television monitor 5 of FIG. 1.

FIG. 6 is a view showing another example of a game screen as displayed on the television monitor 5 of FIG. 1.

FIG. 7 is a view showing a further example of a game screen as displayed on the television monitor 5 of FIG. 1.

FIG. 8A through FIG. 8I are explanatory views for showing input patterns performed with the input devices 3L and 3R of FIG. 1.

FIG. 9A through FIG. 9L are explanatory views for showing input patterns performed with the input devices 3L and 3R of FIG. 1.

FIG. 10 is a flow chart showing an example of the overall process flow of the information processing apparatus 1 of FIG. 1.

FIG. 11 is a flow chart showing an example of the image capturing process of step S2 of FIG. 10.

FIG. 12 is a flow chart for showing an exemplary sequence of the process of extracting a target point in step S3 of FIG. 10.

FIG. 13 is a flow chart showing an example of the process of determining an input operation in step S4 of FIG. 10.

FIG. 14 is a flow chart showing an example of the process of determining a swing in step S5 of FIG. 10.

FIG. 15 is a flow chart showing an example of the right and left determination process in step S6 of FIG. 10.

FIG. 16 is a flow chart showing an example of the effect control process in step S7 of FIG. 10.

FIG. 17 is a flow chart showing part of an example of the execution determination process of the deadly attack “A” in step S110 of FIG. 16.

FIG. 18 is a flow chart showing the rest of the example of the execution determination process of the deadly attack “A” in step S110 of FIG. 16.

FIG. 19 is a flow chart showing part of an example of the execution determination process of the deadly attack “B” in step S111 of FIG. 16.

FIG. 20 is a flow chart showing the rest of the example of the execution determination process of the deadly attack “B” in step S111 of FIG. 16.

FIG. 21 is a flow chart showing an example of the execution determination process of the special swing attack in step S112 of FIG. 16.

FIG. 22 is a flow chart showing an example of the execution determination process of the normal swing attack in step S113 of FIG. 16.

FIG. 23 is a flow chart showing an example of the execution determination process of the two-handed bomb in step S114 of FIG. 16.

FIG. 24. is a flow chart showing an example of the execution determination process of the one-handed bomb in step S115 of FIG. 16.

### BEST MODE FOR CARRYING OUT THE INVENTION

In what follows, an embodiment of the present invention will be explained in conjunction with the accompanying drawings. Meanwhile, like references indicate the same or functionally similar elements throughout the drawings, and therefore redundant explanation is not repeated.

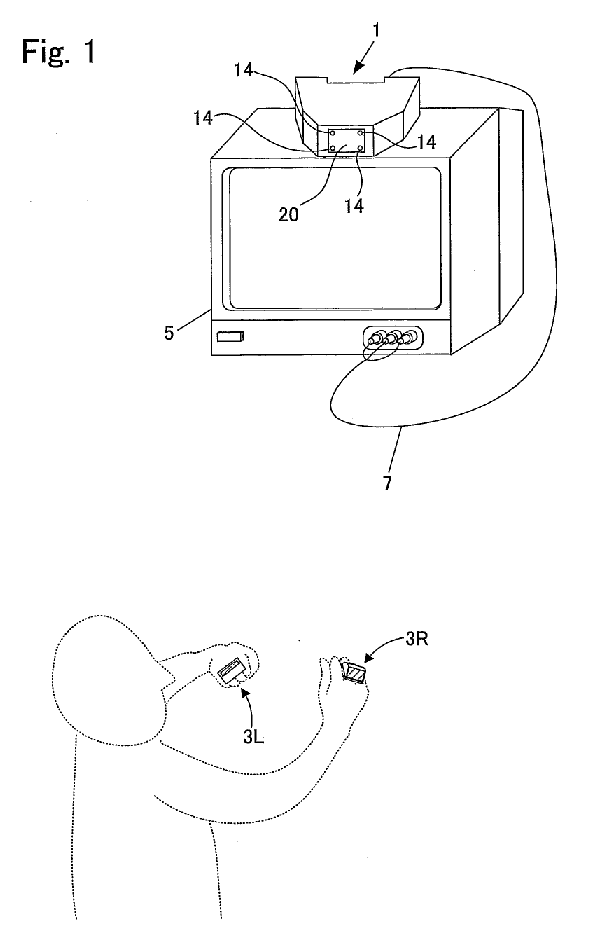

FIG. 1 is a block diagram showings the entire configuration of an information processing system in accordance with an embodiment of the present invention. As shown in FIG. 1, this information processing system comprises an information processing apparatus 1, input devices 3L and 3R relating to the present invention, and a television monitor 5, and serves as an entertainment system relating to the present invention for performing a simulated experience method relating to the present invention. In the following description, the input devices 3L and 3R are referred to simply as the input device 3 unless it is necessary to distinguish them.

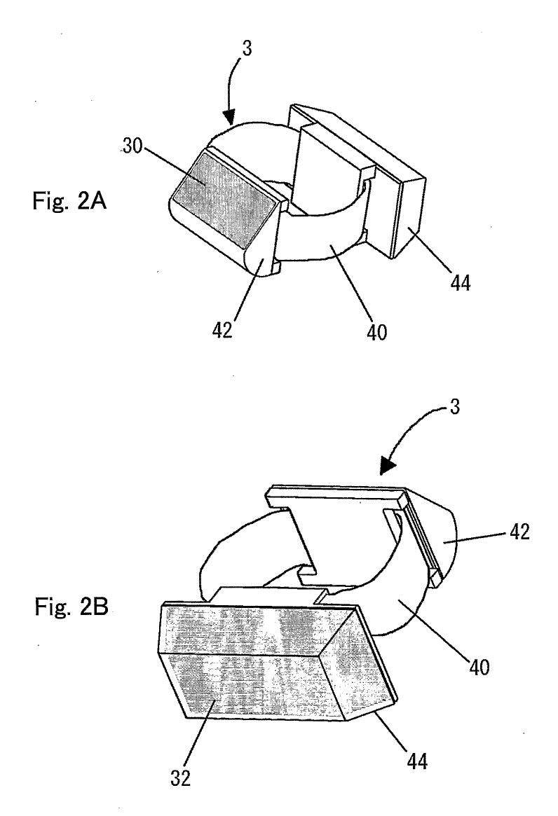

FIG. 2A and FIG. 2B are perspective views for showing the input device 3 of FIG. 1. As shown in these figures, the input device 3 comprises a transparent member 42, a transparent member 44 and a belt 40 which is passed through a passage formed along the bottom face of each of the transparent member 42 and the transparent member 44 and fixed at the inside of the transparent member 42. The transparent member 42 is provided with a flat slope face to which a rectangular retroreflective sheet 30 is attached.

On the other hand, the transparent member 44 is formed to be hollow inside and provided with a retroreflective sheet 32 covering the entirety of the inside of the transparent member 44 (except for the bottom side). The usage of the input device 3 will be described later. In this description, in the case where it is necessary to distinguish between the input devices 3L and 3R, the transparent member 42, the retroreflective sheet 30, the transparent member 44 and the retroreflective sheet 32 of the input device 3L are referred to as the transparent member 42L, the retroreflective sheet 30L, the transparent member 44L and the retroreflective sheet 32L, and the transparent member 42, the retroreflective sheet 30, the transparent member 44 and the retroreflective sheet 32 of the input device 3R are referred to as the transparent member 42R, the retroreflective sheet 30R, the transparent member 44R and the retroreflective sheet 32R.

Returning to FIG. 1, the information processing apparatus 1 is connected to a television monitor 5 by an AV cable 7. Furthermore, although not shown in the figure, the information processing apparatus 1 is supplied with a power supply voltage from an AC adapter or a battery. A power switch (not shown in the figure) is provided in the back face of the information processing apparatus 1.

The information processing apparatus 1 is provided with an infrared filter 20 which is located in the front side of the information processing apparatus 1 and serves to transmit only infrared light, and there are four infrared light emitting diodes 14 which are located around the infrared filter 20 and serve to emit infrared light. An image sensor 12 to be described below is located behind the infrared filter 20.

The four infrared light emitting diodes 14 intermittently emit infrared light. Then, the infrared light emitted from the infrared light emitting diodes 14 is reflected by the retroreflective sheet 30 or 32 attached to the input device 3, and input to the image sensor 12 located behind the infrared filter 20. An image of the input device 3 can be captured by the image sensor 12 in this way. While infrared light is intermittently emitted, the image sensor 12 is operated to capture images even in non-emission periods of infrared light. The information processing apparatus 1 calculates the difference between the image captured with infrared light illumination and the image captured without infrared light illumination when an operator moves the input device 3, and calculates the location and the like of the input device 3 (that is, the retroreflective sheet 30 or 32) on the basis of this differential signal “DI” (differential image “DI”).

It is possible to eliminate, as much as possible, noise of light other than the light reflected from the retroreflective sheets 30 and 32 by obtaining the difference so that the retroreflective sheets 30 and 32 can be detected with a high degree of accuracy.

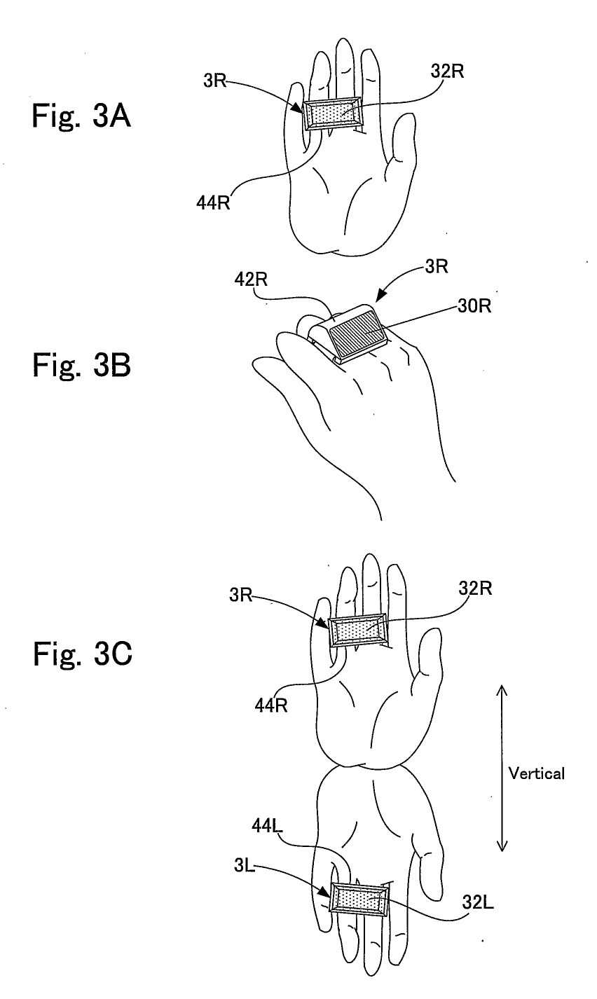

FIG. 3A is an explanatory view for showing an exemplary usage of the input device 3 of FIG. 1. FIG. 3B is an explanatory view for showing another exemplary usage of the input device 3 of FIG. 1. FIG. 3C is an explanatory view for showing a further exemplary usage of the input device 3 of FIG. 1.

As illustrated in FIG. 3A, for example, the operator inserts his middle and annular fingers through the belt 40 from the side near the retroreflective sheet 30R of the transparent member 42R (refer to FIG. 2A), and grips the transparent member 44R as illustrated in FIG. 3B. Then, the transparent member 44R, i.e., the retroreflective sheet 32R is hidden in the hand so that an image thereof is not captured by the image sensor 12. In this case, however, the transparent member 42R is located over the outside of the fingers so that an image thereof can be captured by the image sensor 12. Returning to FIG. 3A, if the operator opens the hand to make it face the image sensor 12, the transparent member 44R, i.e., the retroreflective sheet 32R is exposed, and then an image thereof can be captured. The input device 3L is put on the left hand and can be used in the same manner as the input device 3R.

The operator may or may not have the image sensor 12 capture an image of the retroreflective sheet 32 by the action of opening or closing a hand in order to give an input to the information processing apparatus 1. In this case, since the retroreflective sheet 30 of the transparent member 42 located in the back face of the fingers is arranged in order to face the operator, the retroreflective sheet 30 is out of the imaging range of the image sensor 12, and thereby it is possible to capture an image only of the retroreflective sheet 32 of the transparent member 44 even if an input operation as described above is performed. On the other hand, the operator can have the image sensor 12 capture an image only of the retroreflective sheet 30 of the transparent member 42 by taking a swing (throwing a punch such as a hook) with a clenching hand.

As shown in FIG. 3C, the operator can perform an input operation to the information processing apparatus 1 by opening both the hands with their wrists being in close contact in order that the palm sides thereof are opened in the vertical direction to have the image sensor 12 capture images of the two retroreflective sheets 32L and 32R arranged in the vertical direction. Of course, this is possible also in the horizontal direction.

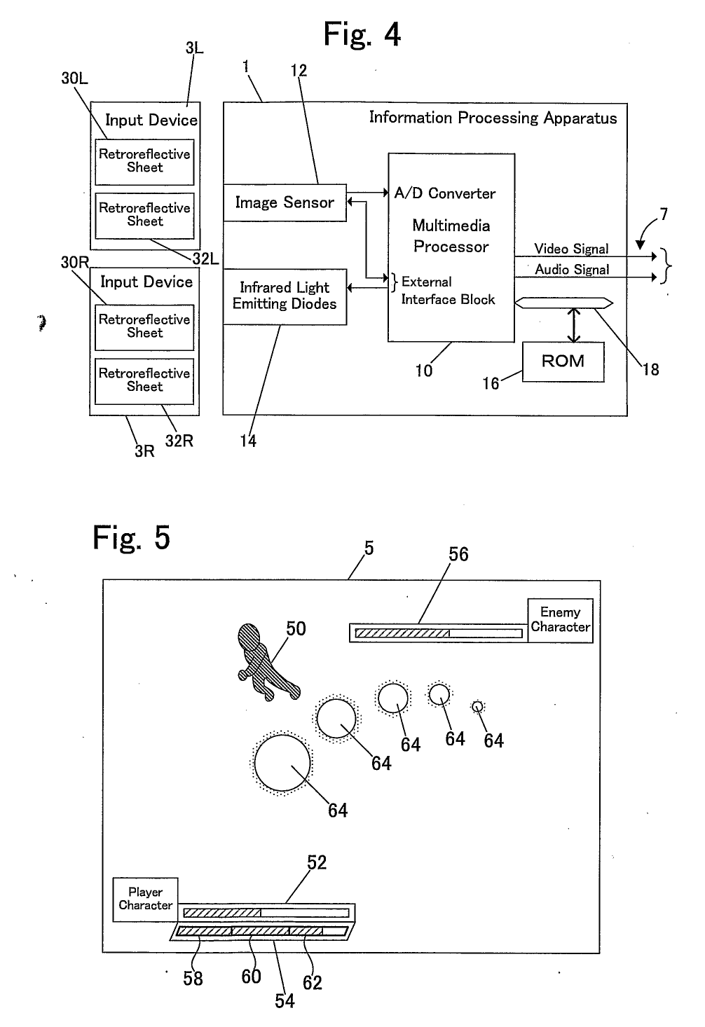

FIG. 4 is a view showing the electric configuration of the information processing apparatus 1 of FIG. 1. As shown in FIG. 4, the information processor 1 includes a multimedia processor 10, an image sensor 12, infrared light emitting diodes 14, a ROM (read only memory) 16 and a bus 18.

The multimedia processor 10 can access the ROM 16 through the bus 18. Accordingly, the multimedia processor 10 can perform a program stored in the ROM 16, and read and process the data stored in the ROM 16. The program, image data, sound data and the like data are written to in this ROM 16 in advance.

Although not shown in the figure, this multimedia processor is provided with a central processing unit (referred to as the “CPU” in the following description), a graphics processing unit (referred to as the “GPU” in the following description), a sound processing unit (referred to as the “SPU” in the following description), a geometry engine (referred to as the “GE” in the following description), an external interface block, a main RAM, an A/D converter (referred to as the “ADC” in the following description) and so forth.

The CPU performs various operations and controls the overall system in accordance with the program stored in the ROM 16. The CPU performs the process relating to graphics operations, which are performed by running the program stored in the ROM 16, such as the calculation of the parameters required for the expansion, reduction, rotation and/or parallel displacement of the respective objects and the calculation of eye coordinates (camera coordinates) and view vector. In this description, the term “object” is used to indicate a unit which is composed of one or more polygons or sprites and to which expansion, reduction, rotation and parallel displacement transformations are applied in an integral manner.

The GPU serves to generate a three-dimensional image composed of polygons and sprites on a real time base, and converts it into an analog composite video signal. The SPU generates PCM (pulse code modulation) wave data, amplitude data, and main volume data, and generates analog audio signals from them by analog multiplication. The GE performs geometry operations for displaying a three-dimensional image. Specifically, the GE executes arithmetic operations such as matrix multiplications, vector affine transformations, vector orthogonal transformations, perspective projection transformations, the calculations of vertex brightnesses/polygon brightnesses (vector inner products), and polygon back face culling processes (vector cross products).

The external interface block is an interface with peripheral devices (the image sensor 12 and the infrared light emitting diodes 14 in the case of the present embodiment) and includes programmable digital input/output (I/O) ports of 24 channels. The ADC is connected to analog input ports of 4 channels and serves to convert an analog signal, which is input from an analog input device (the image sensor 12 in the case of the present embodiment) through the analog input port, into a digital signal. The main RAM is used by the CPU as a work area, a variable storing area, a virtual memory system management area and so forth.

By the way, the input device 3 is illuminated with the infrared light which is emitted from the infrared light emitting diodes 14, and then the illuminating infrared light is reflected by the retroreflective sheet 30 or 32. The image sensor 12 receives the reflected light from this retroreflective sheet 30 or 32 for capturing an image, and outputs an image signal which includes an image of the retroreflective sheet 30 or 32. As described above, the multimedia processor 10 has the infrared light emitting diodes 14 intermittently flash for performing stroboscopic imaging, and thereby the image sensor 12 outputs an image signal which is obtained without infrared light illumination. These analog signals output from the image sensor 12 are converted into digital data by an ADC incorporated in the multimedia processor 10.

The multimedia processor 10 generates the differential signal “DI” (differential image “DI”) as described above from the digital signals input from the image sensor 12 through the ADC. Then the multimedia processor 10 determines whether or not there is an input from the input device 3 on the basis of the differential signal “DI”, computes the position and so forth of the input device 3 on the basis of the differential signal(s) “DI”, performs a graphics process, a sound process and other processes and computations, and outputs a video signal and audio signals. The video signal and the audio signals are supplied to the television monitor 5 through the AV cable 7 in order to display an image on the television monitor 5 corresponding to the video signal while sounds are output from the speaker thereof (not shown in the figure) corresponding to the audio signals.

By the way, next is the explanation of several examples of input operations to the information processing apparatus 1 through the input device 3, and exemplary responses of the information processing apparatus 1 to the input operations, while suitably referring to FIG. 5 through FIG. 7. FIG. 5 through FIG. 7 respectively show several exemplary screens which are displayed in the player's view during a battle game in which a player character fights against an enemy character. Accordingly, the player character is not displayed in the game screen.

FIG. 5 is a view showing an example of a game screen as displayed on the television monitor 5 of FIG. 1. As shown in FIG. 5, this game screen includes the enemy character 50, a physical energy gauge 56 indicating the physical energy of the enemy character 50, a physical energy gauge 52 indicating the physical energy of the player character, and a spiritual energy gauge 54 indicating the spiritual energy of the player character. The physical energy indicated by the physical energy gauge 52 and 56 decreases each time the opponent makes an effective attack.

When any one of the retroreflective sheets 30L, 30R, 32L and 32R is detected (image captured) after the no-input state (that is, in which none of the retroreflective sheets 30L, 30R, 32L and 32R is detected (image captured)) in the case of a long range combat (in which the distance between the enemy character and the player character exceeds a predetermined value in a virtual space), as shown in FIG. 5, the information processing apparatus 1 successively displays, on the television monitor 5, attack objects 64 (referred to as the bullet objects 64 in the following description) which are flying away from the position corresponding to the position of the retroreflective sheet as detected toward a deeper area of the screen (automatic successive firing). Accordingly, it is possible to hit the enemy character 50 with the bullet object 64 by performing such an input operation in an appropriate position.

In this case, one of the retroreflective sheets 30L, 30R, 32L and 32R is detected after the no-input state when, for example, one hand gripping the transparent member 44 is opened to face the image sensor 12 (the information processing apparatus 1) so that an image of the retroreflective sheet 32 is captured.

The spiritual energy indicated by the spiritual energy gauge 54 decreases in accordance with the number of the bullet objects 64 having appeared (i.e., the number of fires). As thus described, the spiritual energy indicated by the spiritual energy gauge 54 decreases with each fire, and falls to “0” at once when a deadly attack “A” or “B” is fired, but after a predetermined time elapses the spiritual energy is recovered. The speed of automatic firing of the bullet objects 64 varies depending upon which of an area 58, an area 60 or an area 62, the spiritual energy as indicated by the spiritual energy gauge 54 reaches.

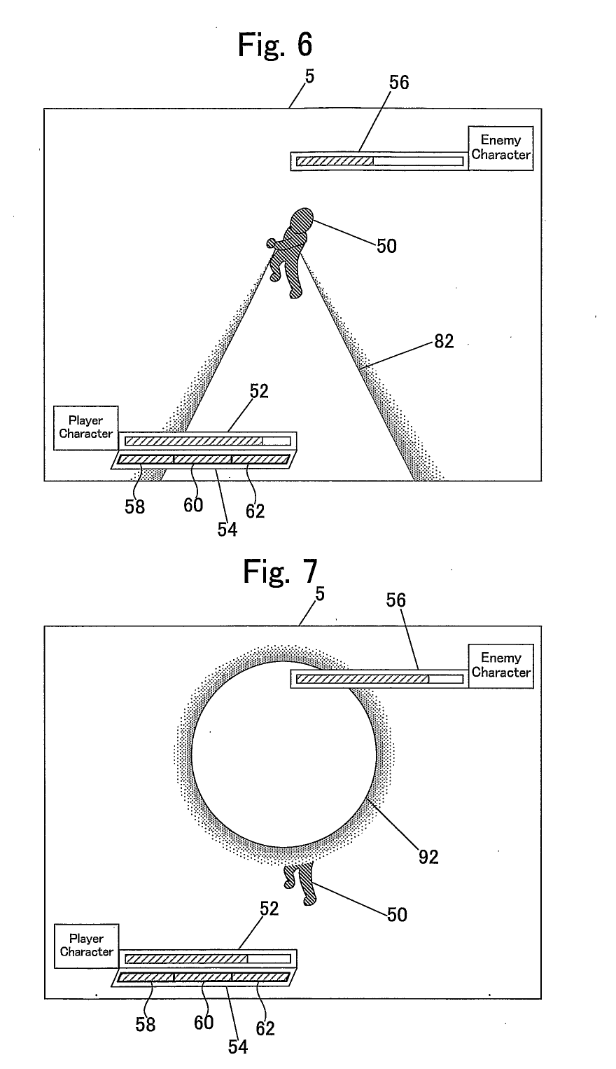

FIG. 6 is a view showing another example of a game screen as displayed on the television monitor 5 of FIG. 1. If two retroreflective sheets are detected (image captured) beyond a predetermined time period such that they are aligned in the vertical direction, as illustrated in FIG. 6, the information processing apparatus 1 displays an attack object 82 (referred to as the “attack wave 82” in the following description) extending toward a deeper area of the screen on the television monitor 5 (the deadly attack A).

In this case, the information processing apparatus 1 determines that the two retroreflective sheets aligned in the vertical direction are detected if it is satisfied as determination requirements that the difference between the horizontal coordinate of one retroreflective sheet and the horizontal coordinate of the other retroreflective sheet is smaller than a predetermined horizontal value in the above differential image “DI” calculated on the basis of the signals output from the image sensor 12 and that the difference between the vertical coordinate of said one retroreflective sheet and the vertical coordinate of said the other retroreflective sheet is greater than a predetermined vertical value in the above differential image “DI”. Incidentally, it is satisfied that the predetermined horizontal value<the predetermined vertical value.

In this case, for example, if the retroreflective sheets 32L and 32R are detected as illustrated in FIG. 3C, the two retroreflective sheets are detected as being aligned in the vertical direction.

By the way, the information processing apparatus 1 may be provided with a hidden parameter which is increased when the operator skillfully fights or defends, and reflected in the development of the game. It may be added as the condition required for using the above deadly attack “A” that this hidden parameter exceeds a first predetermined value.

FIG. 7 is a view showing a further example of a game screen as displayed on the television monitor 5 of FIG. 1. If two retroreflective sheets are detected (image captured) beyond a predetermined time period such that they are aligned in the vertical direction beyond the predetermined time period and the hidden parameter is greater than a second predetermined value (>the first predetermined value), the information processing apparatus 1 displays an attack object 92 (referred to as the attack ball 92) on the television monitor 5 as illustrated in FIG. 7.

Then, after the two retroreflective sheets aligned in the horizontal direction are detected (image captured), if they are moved upward in the vertical direction (that is, if the player separates both hands and moves both arms upward in the vertical direction), the attack ball 92 also moves upward in the vertical direction in association with this action, and if the two retroreflective sheets are moved downward in the vertical direction (that is, if the player separates both hands and moves both arms downward in the vertical direction), the attack ball 92 also moves downward in the vertical direction in association with this action and then explodes (the deadly attack B).

Other than the above examples, there are the following input operations and the responses corresponding thereto. The information processing apparatus 1 can display a shield object which moves in response to the motion of the retroreflective sheet as detected on the television monitor 5 if any one of the retroreflective sheets 30L, 30R, 32L and 32R is detected (image captured) in the case of a long range combat and moves in the differential image “DI” as described above at a velocity higher than a predetermined velocity. The attack of the enemy character can be defended by this shield object.

Also, when two retroreflective sheets aligned in the horizontal direction are detected (image captured) beyond a predetermined time, the information processing apparatus 1 can quickly charge the spiritual energy indicated by the spiritual energy gauge 54. Furthermore, the information processing apparatus 1 can increase an offensive power parameter indicative of the offensive power (transformation of the player character) if two retroreflective sheets aligned in the horizontal direction are detected (image captured) beyond a predetermined time while the spiritual energy gauge 54 indicates a fully charged state in the case of a long range combat.

When any one of the retroreflective sheets 30L, 30R, 32L and 32R is detected (image captured) after the no-input state in the case of a short range combat (the distance between the enemy character and the player character is less than or equal to a predetermined value in the virtual space), the information processing apparatus 1 displays, on the television monitor 5, a punch throw leaving a trail from the position corresponding to the position of the retroreflective sheet as detected toward a deeper area of the screen. Accordingly, it is possible to hit the enemy character 50 with a punch by performing such an input operation in an appropriate position.

The information processing apparatus 1 can display a punch throw leaving a trail in accordance with the motion of the retroreflective sheet as detected on the television monitor 5 if any one of the retroreflective sheets 30L, 30R, 32L and 32R is detected (image captured) in the case of a short range combat and moves in the differential image “DI” as described above at a velocity higher than a predetermined velocity. Accordingly, it is possible to hit the enemy character 50 with a punch by performing such an input operation in an appropriate position.

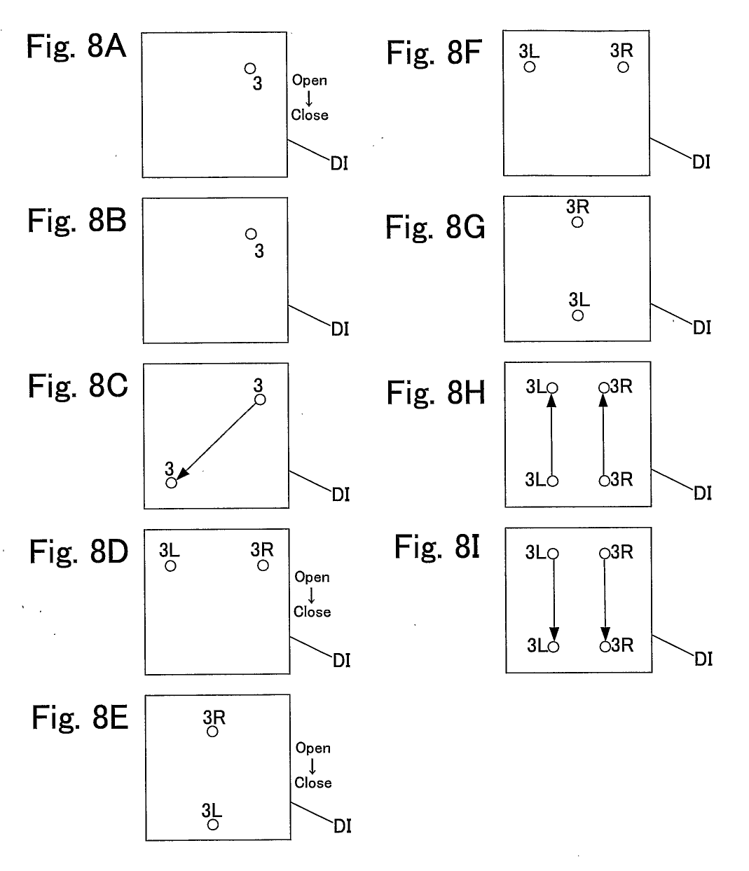

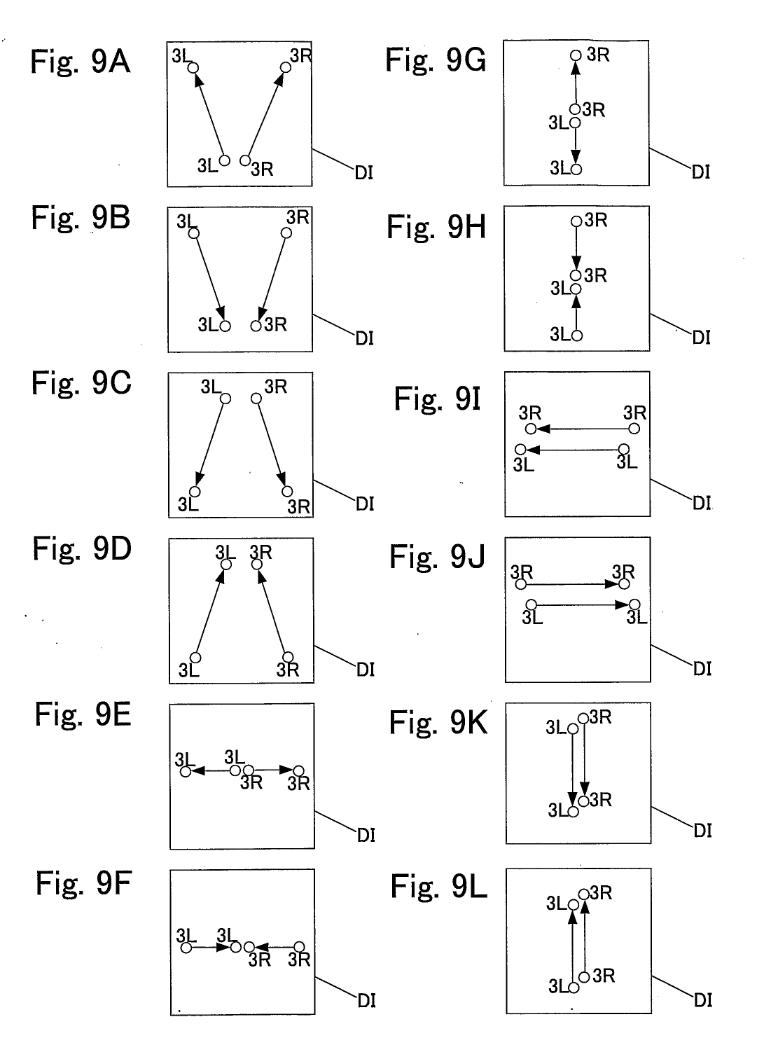

Next is the explanation of the types of input operations by making use of the input device 3. Meanwhile, the determination of an input operation is performed by the multimedia processor 10 on the basis of the differential image “DI” each time the video frame is updated (for example, at 1/60 second intervals). FIG. 8A through FIG. 8I and FIG. 9A through FIG. 9L are explanatory views for showing input patterns performed by the input device 3 of FIG. 1. As illustrated in FIG. 8A, the multimedia processor 10 can determine that a first input operation is performed, when an image is captured of a retroreflective sheet of either input device 3 after the state in which no image is captured of both the input devices 3 by the image sensor 12. For example, this is the case where the player grasping the input devices 3 opens one of the clenching hands.

As illustrated in FIG. 8B, the multimedia processor 10 can determine that a second input operation is performed, when an image is continuously captured of the retroreflective sheet of any one of the input devices 3. For example, this is the case where the player grasping the input devices 3 is continuously opening one of the hands while clenching the other hand.

As illustrated in FIG. 8C, the multimedia processor 10 can determine that a third input operation is performed, when one of the input devices 3 is moved at a velocity higher than a predetermined velocity, irrespective of the direction of the motion. For example, this is the case where the player grasping the input devices 3 moves one of the hands which is opening, while clenching the other hand, or when the player throws a punch (for example, a hook) with one of the hands, while clenching both the hands.

As illustrated in FIG. 8D, the multimedia processor 10 can determine that a fourth input operation is performed, when images are captured of the retroreflective sheets of both the input devices 3L and 3R after the state in which no image is captured of both the input devices 3L and 3R by the image sensor 12, if the distance between them in the horizontal direction is greater than a first horizontal predetermined value but the distance between them in the vertical direction is less than or equal to a first vertical predetermined value. For example, this is the case where the player grasping the input devices 3 opens both the clenching hands which are aligned in the horizontal direction. It is satisfied that the first horizontal predetermined value>the first vertical predetermined value. Incidentally, it is possible to determine that the fourth input operation is performed when images are captured of the retroreflective sheets of both the input devices 3L and 3R after the state in which no image is captured of both the input devices 3L and 3R by the image sensor 12.

As illustrated in FIG. 8E, the multimedia processor 10 can determine that a fifth input operation is performed, when images are captured of the retroreflective sheets of both the input devices 3L and 3R after the state in which no image is captured of both the input devices 3L and 3R by the image sensor 12, if the distance between them in the horizontal direction is less than or equal to a second horizontal predetermined value but the distance between them in the vertical direction is greater than a second vertical predetermined value. For example, this is the case where the player grasping the input devices 3 opens both the clenching hands which are aligned in the vertical direction. It is satisfied that the second horizontal predetermined value>the second vertical predetermined value.

As illustrated in FIG. 8F, the multimedia processor 10 can determine that a sixth input operation is performed, when images are continuously captured of the retroreflective sheets of both the input devices 3L and 3R, if the distance between them in the horizontal direction is greater than the first horizontal predetermined value but the distance between them in the vertical direction is less than or equal to the first vertical predetermined value. For example, this is the case where the player grasping the input devices 3 is continuously opening both the clenching hands which are aligned in the horizontal direction. Incidentally, it is possible to determine that the sixth input operation is performed when images are continuously captured of the retroreflective sheets of both the input devices 3L and 3R.

As illustrated in FIG. 8G, the multimedia processor 10 can determine that a seventh input operation is performed, when images are continuously captured of the retroreflective sheets of both the input devices 3L and 3R, if the distance between them in the horizontal direction is less than or equal to the second horizontal predetermined value but the distance between them in the vertical direction is greater than the second vertical predetermined value. For example, this is the case where the state as shown in FIG. 3C continues.

As illustrated in FIG. 8H, the multimedia processor 10 can determine that an eighth input operation is performed, when each of the input devices 3L and 3R is moved upward in the vertical direction at a velocity higher than a predetermined velocity. For example, this is the case where the player grasping the input devices 3 moves upward in the vertical direction the hands which are opened and aligned in the horizontal direction, while they are kept open.

As illustrated in FIG. 8I, the multimedia processor 10 can determine that a ninth input operation is performed, when each of the input devices 3L and 3R is moved downward in the vertical direction at a velocity higher than a predetermined velocity. For example, this is the case where the player grasping the input devices 3 moves downward in the vertical direction the hands which are opened and aligned in the horizontal direction, while they are kept opened.

As illustrated in FIG. 9A, the multimedia processor 10 can determine that a tenth input operation is performed, when each of the input devices 3L and 3R is moved upward in an oblique direction to come away from the other at a velocity higher than a predetermined velocity. For example, this is the case where the player grasping the input devices 3 moves upward in oblique directions the hands which are opened and first positioned close to each other in the horizontal direction in order that the hands come away from each other, while they are kept opened.

As illustrated in FIG. 9B, the multimedia processor 10 can determine that an eleventh input operation is performed, when each of the input devices 3L and 3R is moved downward in an oblique direction to come close to the other at a velocity higher than a predetermined velocity. For example, this is the case where the player grasping the input devices 3 moves downward in oblique directions the hands which are opened and first positioned apart from each other in the horizontal direction in order that the hands come close to each other, while they are kept opened.

As illustrated in FIG. 9C, the multimedia processor 10 can determine that a twelfth input operation is performed, when each of the input devices 3L and 3R is moved downward in an oblique direction to come away from the other at a velocity higher than a predetermined velocity. For example, this is the case where the player grasping the input devices 3 moves downward in oblique directions the hands which are opened and first positioned close to each other in the horizontal direction in order that the hands come away from each other, while they are kept opened.

As illustrated in FIG. 9D, the multimedia processor 10 can determine that a thirteenth input operation is performed, when each of the input devices 3L and 3R is moved upward in an oblique direction to come close to the other at a velocity higher than a predetermined velocity. For example, this is the case where the player grasping the input devices 3 moves upward in oblique directions the hands which are opened and first positioned apart from each other in the horizontal direction in order that the hands come close to each other, while they are kept opened.

As illustrated in FIG. 9E, the multimedia processor 10 can determine that a fourteenth input operation is performed, when the input devices 3L and 3R are moved respectively in the right and left directions apart from each other at a velocity higher than a predetermined velocity. For example, this is the case where the player grasping the input devices 3 moves in the right and left directions the hands which are opened and first positioned close to each other in the horizontal direction in order to spread the hands apart from each other, while they are kept opened.

As illustrated in FIG. 9F, the multimedia processor 10 can determine that a fifteenth input operation is performed, when the input devices 3L and 3R first positioned apart from each other in the horizontal direction are moved to approach close to each other at a velocity higher than a predetermined velocity. For example, this is the case where the player grasping the input devices 3 moves the hands which are first positioned apart from each other in the horizontal direction in order that they approach close to each other, while they are kept opened.

As illustrated in FIG. 9G, the multimedia processor 10 can determine that a sixteenth input operation is performed, when the input devices 3L and 3R are moved away in the up and down directions at a velocity higher than a predetermined velocity. For example, this is the case where the player grasping the input devices 3 moves in the up and down directions the hands which are opened and first positioned close to each other in the vertical direction in order to spread the hands apart from each other respectively in the up and down directions, while they are kept opened.

As illustrated in FIG. 9H, the multimedia processor 10 can determine that a seventeenth input operation is performed, when the input devices 3L and 3R first positioned apart from each other in the vertical direction are moved to approach close to each other at a velocity higher than a predetermined velocity. For example, this is the case where the player grasping the input device 3 moves the hands which are first positioned apart from each other in the vertical direction in order that they approach close to each other, while they are kept opened.

As illustrated in FIG. 9I, the multimedia processor 10 can determine that an eighteenth input operation is performed, when each of the input devices 3L and 3R positioned close to each other is moved from the right to the left at a velocity higher than a predetermined velocity. For example, this is the case where the player grasping the input device 3 moves the hands positioned close to each other from the right to the left, while they are kept opened.

As illustrated in FIG. 9J, the multimedia processor 10 can determine that a nineteenth input operation is performed, when each of the input devices 3L and 3R positioned close to each other is moved from the left to the right at a velocity higher than a predetermined velocity. For example, this is the case where the player grasping the input device 3 moves the hands positioned close to each other from the left to the right, while they are kept opened.

As illustrated in FIG. 9K, the multimedia processor 10 can determine that a twentieth input operation is performed, when each of the input devices 3L and 3R positioned close to each other is moved from the top to the bottom at a velocity higher than a predetermined velocity. For example, this is the case where the player grasping the input device 3 moves the hands positioned close to each other from the top to the bottom, while they are kept opened.

As illustrated in FIG. 9K, the multimedia processor 10 can determine that a twenty-first input operation is performed, when each of the input devices 3L and 3R positioned close to each other is moved from the bottom to the top at a velocity higher than a predetermined velocity. For example, this is the case where the player grasping the input device 3 moves the hands positioned close to each other from the bottom to the top, while they are kept opened.

As described above, the twenty-one exemplary types of input operations have been explained. Accordingly, in this example, the multimedia processor 10 performs arithmetic operations corresponding to the respective input operations in order to generate images corresponding to the respective input operations. In addition to this, even if the same type of an input operation is performed, it is possible to perform a different responses (generate a different image) depending upon the scene (for example, a long range combat or a short range combat, the transformation of the player character, a parameter varying with the advance of the game (for example, the hidden parameter) or a combination thereof).

Also, by determining a particular input operation when a combination of predetermined input operations is performed in a predetermined order, it is possible to perform a particular arithmetic operation corresponding to this particular input operation, and generate a corresponding image. Furthermore, it is possible to perform different responses (generate different images), even if the same combination of predetermined input operations is performed in the predetermined order, depending upon the scene (for example, a long range combat or a short range combat, the transformation of the player character, a parameter varying with the advance of the game (for example, the hidden parameter) or a combination thereof).

In addition to this, it may be used as the condition required for performing a predetermined response that a certain input state is continued for a predetermined or a longer period. Also, it may be used as the condition required for performing a predetermined response that there is a predetermined or an arbitrary voice input. In this case, it is needed to provide an appropriate voice input device such as a microphone.

Several examples of the responses to the input operations will be described. Next is an explanation of the condition on which the multimedia processor 10 generates the image 82 of the deadly attack “A” as described above. Character indication or the like indication are displayed on the television monitor 5 in order to indicate a state in which it is possible to wield the deadly attack “A” by the multimedia processor 10. It is used as the condition required for wielding the deadly attack “A” that the fifth input operation of FIG. 8E is performed while this indication is displayed. Then, the multimedia processor 10 generates and displays the image 82 of the deadly attack “A” on the television monitor 5 when there is the seventh input operation of FIG. 8G after the no-input state is continued in which no image is captured of any input device 3 for a predetermined or a longer period.

Next is an explanation of the condition on which the multimedia processor 10 generates the image 92 of the deadly attack “B” as described above. Character indication or the like indication are displayed on the television monitor 5 in order to indicate a state in which it is possible to wield the deadly attack “B” by the multimedia processor 10. It is used as the condition required for wielding the deadly attack “B” that the fifth input operation of FIG. 8E is performed while this indication is displayed. Then, if the sixth input operation of FIG. 8F is continuously performed for a predetermined or a longer period, after performing the eighth input operation of FIG. 8H, and thereafter the ninth input operation of FIG. 8I is performed, the multimedia processor 10 generates and displays the image 92 of the deadly attack “B” on the television monitor 5.

Next is an explanation of the condition on which the multimedia processor 10 generates the image of the deadly attack “C” (not shown in the figure). Character indication or the like indication are displayed on the television monitor 5 in order to indicate a state in which it is possible to wield the deadly attack “C” by the multimedia processor 10. It is used as the condition required for wielding the deadly attack “C” that the fifth input operation of FIG. 8E is performed while this indication is displayed. Then, if the sixth input operation of FIG. 8F is continuously performed for a predetermined or a longer period followed by the no-input state and thereafter the third input operation of FIG. 8C is performed by moving the input device 3 from the bottom to the top in the vertical direction, the multimedia processor 10 generates and displays the image of the deadly attack “C” on the television monitor 5.

Next is an explanation of the condition on which the multimedia processor 10 generates the image of the deadly attack “D” (not shown in the figure). Character indication or the like indication are displayed on the television monitor 5 in order to indicate a state in which it is possible to wield the deadly attack “D” by the multimedia processor 10. It is used as the condition required for wielding the deadly attack “D” that the fifth input operation of FIG. 8E is performed while this indication is displayed. Then, if the second input operation of FIG. 8B is continuously performed for a predetermined or a longer period followed by the no-input state and thereafter the first input operation of FIG. 8A is performed, the multimedia processor 10 generates and displays the image of the deadly attack “D” on the television monitor 5.

Next is an explanation of the condition on which the multimedia processor 10 generates the image of the deadly attack “E” (not shown in the figure). Character indication or the like indication are displayed on the television monitor 5 in order to indicate a state in which it is possible to wield the deadly attack “E” by the multimedia processor 10. It is used as the condition required for wielding the deadly attack “E” that the fifth input operation of FIG. 8E is performed while this indication is displayed. Then, if the tenth input operation of FIG. 9A is performed and thereafter the fifteenth input operation of FIG. 9F is performed, the multimedia processor 10 generates and displays the image of the deadly attack “E” on the television monitor 5.

Next is an explanation of the condition on which the multimedia processor 10 generates the image of the deadly attack “F” (not shown in the figure). Character indication or the like indication are displayed on the television monitor 5 in order to indicate a state in which it is possible to wield the deadly attack “F” by the multimedia processor 10. It is used as the condition required for wielding the deadly attack “F” that the fifth input operation of FIG. 8E is performed while this indication is displayed. Then, if the sixth input operation of FIG. 8F is continuously performed for a predetermined or a longer period and thereafter the first input operation of FIG. 8A is performed, the multimedia processor 10 generates and displays the image of the deadly attack “F” on the television monitor 5.

Next is an explanation of the condition on which the multimedia processor 10 generates the image of the deadly attack “G” (not shown in the figure). Character indication or the like indication are displayed on the television monitor 5 in order to indicate a state in which it is possible to wield the deadly attack “G” by the multimedia processor 10. It is used as the condition required for wielding the deadly attack “G” that the fifth input operation of FIG. 8E is performed while this indication is displayed. Then, if the eighth input operation of FIG. 8H is performed and thereafter the ninth input operation of FIG. 8I is performed, the multimedia processor 10 generates and displays the image of the deadly attack “G” on the television monitor 5.

Next is the explanation of the condition on which the multimedia processor 10 transforms the player character. The multimedia processor 10 transforms the player character when there is the tenth input operation of FIG. 9A on the condition that the power consumption of the physical energy reaches a predetermined amount (for example, a ⅛ of the full capacity). In this case, even if the same type of an input operation is performed, it is possible to use a different image corresponding to a deadly attack depending upon the transformation state of the player character.

Next is an explanation of the condition on which the multimedia processor 10 generates the image of an attack object sh1 (not shown in the figure). In the case of a long range combat, if the second input operation of FIG. 8B is continuously performed for a predetermined or a longer period followed by the no-input state and thereafter the fourth input operation of FIG. 8D is performed, the multimedia processor 10 generates and displays the image of the attack object sh1 on the television monitor 5.

Next is an explanation of the condition on which the multimedia processor 10 generates the image of a transparent or a semi-transparent beltlike shield object S1 (not shown in the figure). In the case of a long range combat, if the third input operation of FIG. 8C is performed, the multimedia processor 10 generates the image of the shield object SL1 tilted at an angle corresponding to the moving direction of the input device 3 and moving in the moving direction of the input device 3, and displays it on the television monitor 5. The attack of the enemy character can be defended by this shield object SL1.

Next is an explanation of the condition on which the multimedia processor 10 generates the image of a shield object SL2 (not shown in the figure) in a predetermined shape. In the case of a short range combat, if the sixth input operation of FIG. 8F is performed, the multimedia processor 10 generates and displays the image of a shield object SL2 on the television monitor 5. The attack of the enemy character can be defended by this shield object SL2.

Next is an explanation of the condition on which the multimedia processor 10 generates the image of the bullet object 64. In the case of a long range combat, in response to the first input operation of FIG. 8A as a trigger, the multimedia processor 10 generates the bullet objects 64 which are flying away from the position corresponding to the position of the input device 3 as detected toward a deeper area of the screen (automatic fire) in a successive manner as long as the second input operation of FIG. 8B is continuously performed, and displays them on the television monitor 5.

Next is an explanation of the condition on which the multimedia processor 10 generates a straight punch image PC1 (not shown in the figure). In the case of the short range combat, if there is the first input operation of FIG. 8A, the multimedia processor 10 generates and displays the straight punch image PC1 on the television monitor 5.

Next is an explanation of the condition on which the multimedia processor 10 generates a hook punch image PC2 (not shown in the figure). In the case of a short range combat, if there is the third input operation of FIG. 8C, the multimedia processor 10 generates the hook punch image PC2 thrown in the moving direction of the input device 3, and displays it on the television monitor 5.

While the responses as described above have been explained as the examples each of which is responsive to a combination of a plurality of input operations and the examples each of which is responsive to a single input operation, the combination between input operations and responses is not limited thereto.

Next, the process performed by the information processing apparatus 1 of FIG. 1 will be explained with reference to a flow chart.

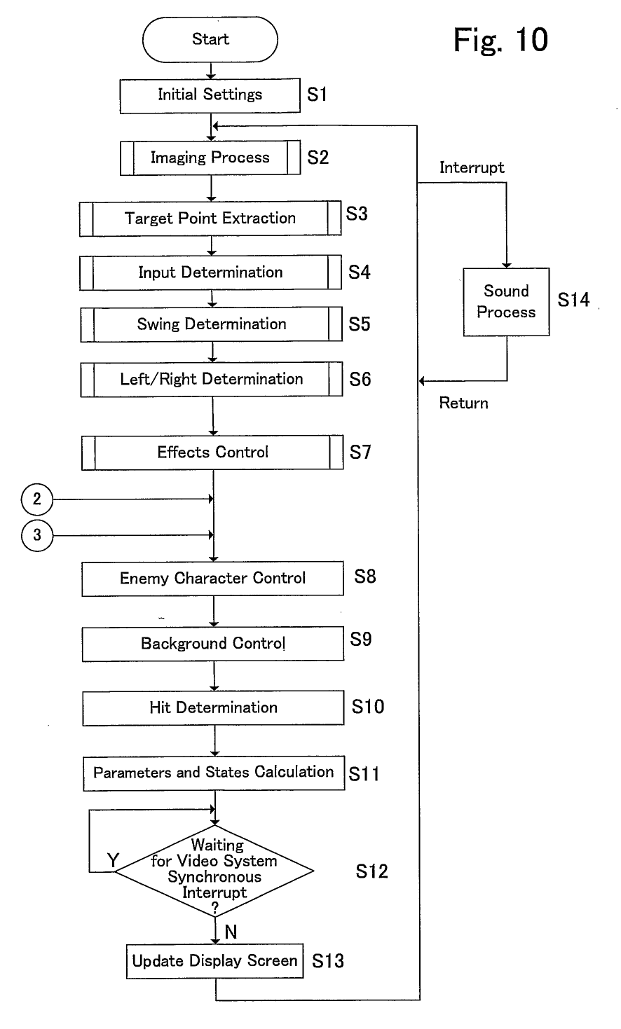

FIG. 10 is a flow chart showing an example of the overall process flow of the information processing apparatus 1 of FIG. 1. As shown in FIG. 10, the multimedia processor 10 performs the initialization process of the system in step S1. This initialization process includes the initial settings of various flags, various counters and other various variables. In step S2, the multimedia processor 10 performs the process of capturing an image of the input device 3 by driving the infrared light emitting diodes 14.

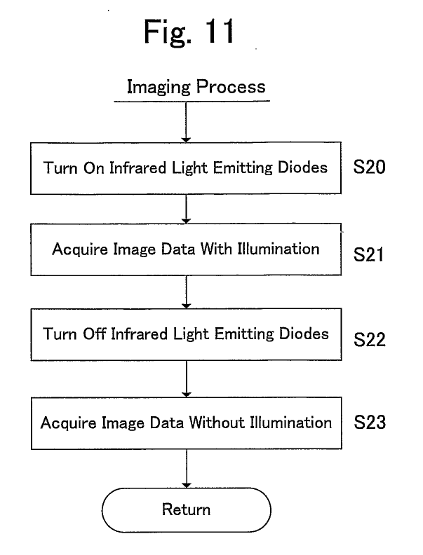

FIG. 11 is a flow chart showing an example of the image capturing process of step S2 of FIG. 10. As shown in FIG. 11, the multimedia processor 10 turns on the infrared light emitting diodes 14 in step S20. In step S21, the multimedia processor 10 acquires, from the image sensor 12, image data which is obtained with infrared light illumination, and stores the image data in the internal main RAM. The image (data) of 32 pixels×32 pixels as generated by the image sensor 12 is referred to as a “sensor image (data)”.

In this case, for example, a CMOS image sensor of 32 pixels×32 pixels is used as the image sensor 12 of the present embodiment. Also, it is assumed that the horizontal axis is X-axis and the vertical axis is Y-axis. Accordingly, the image sensor 12 outputs pixel data of 32 pixels×32 pixels (luminance data of the respective pixels) as sensor image data. All this pixel data is converted into digital data by the ADC and stored in the internal main RAM as the array elements P1[X][Y].

In step S22, the multimedia processor 10 turns off the infrared light emitting diodes 14. In step S23, the multimedia processor 10 acquires, from the image sensor 12, sensor image data (pixel data of 32 pixels×32 pixels) which is obtained without infrared light illumination, converts the sensor image data into digital data and stores the digital data in the internal main RAM. In this case, the sensor image data without infrared light is stored in the array elements P2[X][Y] of the main RAM.

The stroboscope imaging is performed in this way. Meanwhile, since the image sensor 12 of 32 pixels×32 pixels is used in the case of the present embodiment, X=0 to 31 and Y=0 to 31 while the origin is set to the upper left corner with the positive X-axis extending in the horizontal right direction and the positive Y-axis extending in the vertical down direction.

Returning to FIG. 10, in step S3, the multimedia processor 10 performs the process of extracting a target point indicative of the location of the input device 3.

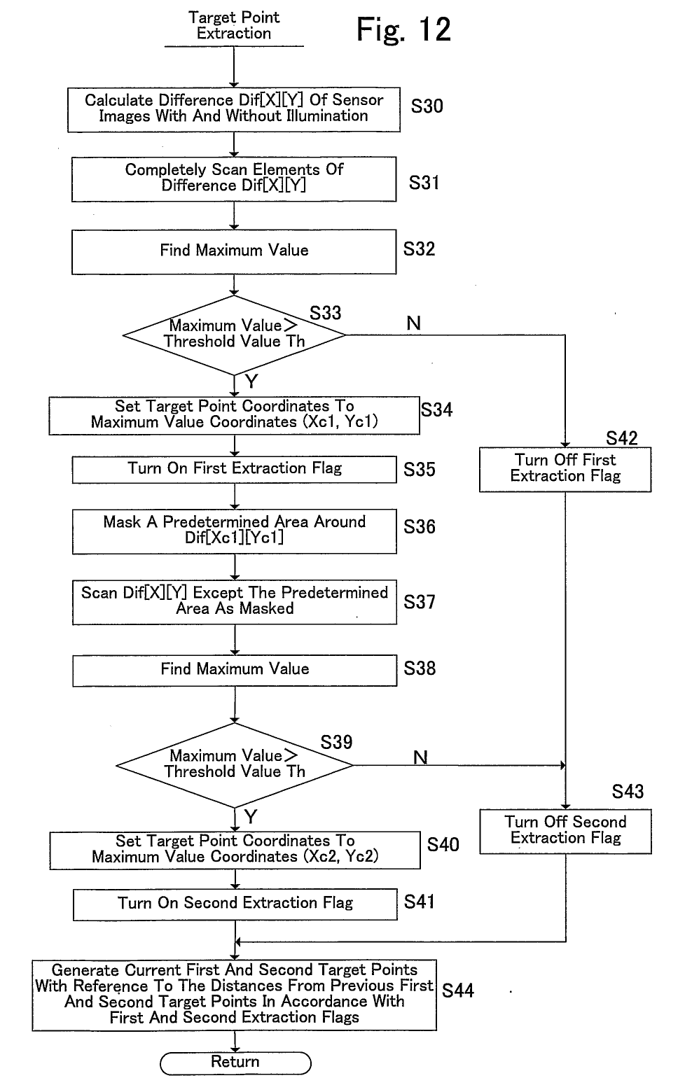

FIG. 12 is a flow chart for showing an exemplary sequence of the process of extracting the target point in step S3 of FIG. 10. As shown in FIG. 12, in step S30, for all the pixels of the sensor image the multimedia processor 10 calculates the differential data between the pixel data P1[X][Y] acquired when the infrared light emitting diodes 14 are turned on and the pixel data P2[X][Y] acquired when the infrared light emitting diodes 14 are turned off, and the differential data is assigned to the respective array elements Dif[X][Y].

As thus described, it is possible to eliminate, as much as possible, noise of light other than the light reflected from the input device 3 (the retroreflective sheets 30 and 32) by calculating the differential data (differential image), and accurately detect the input device 3 (the retroreflective sheets 30 and 32).

In step S31, the multimedia processor 10 completely scans the array elements Dif[X][Y], and finds the maximum value, i.e., the maximum luminance value Dif[Xc1][Yc1], from among them (step S32). In step S33, the multimedia processor 10 compares a predetermined threshold value “Th” with the maximum luminance value as found, and proceeds to step S34 if the maximum luminance value is greater, otherwise proceeds to steps S42 and S43 in which a first extraction flag and a second extraction flag are turned off.

In step S34, the multimedia processor 10 saves the coordinates (Xc1, Yc1) of the pixel having the maximum luminance value Dif[Xc1][Yc1] as the coordinates of a target point. Then, in step S35, the multimedia processor 10 turns on the first extraction flag which indicates that one target point is extracted.

In step S36, the multimedia processor 10 masks a predetermined area around the pixel having the maximum luminance value Dif[Xc1][Yc1]. In step S37, the multimedia processor 10 scans the array elements Dif[X][Y] except for the predetermined area as masked, and finds the maximum value among them, i.e., the maximum luminance value Dif[Xc2][Yc2] (step S38).

In step S39, the multimedia processor 10 compares the predetermined threshold value “The” with the maximum luminance value as found, and proceeds to step S40 if the maximum luminance value is greater, otherwise proceeds to step S43 in which the second extraction flag is turned off.

In step S40, the multimedia processor 10 saves the coordinates (Xc2, Yc2) of the pixel having the maximum luminance value Dif[Xc2][Yc2] as the coordinates of a target point. Then, in step S41, the multimedia processor 10 turns on the second extraction flag which indicates that two target points are extracted.

In step S44, when only the first extraction flag is turned on, the multimedia processor 10 the distance “D1” between a previous first target point and the current target point (Xc1, Yc1) with the distance “D2” between a previous second target point and the current target point (Xc1, Yc1), and the multimedia processor 10 sets the current first target point to the current target point (Xc1, Yc1) if the current target point (Xc1, Yc1) is nearer to the previous first target point and sets the current second target point to the current target point (Xc1, Yc1) if the current target point (Xc1, Yc1) is nearer to the previous second target point. Meanwhile, if the distance “D1” is equal to the distance “D2”, the multimedia processor 10 sets the current first target point to the current target point (Xc1, Yc1).

On the other hand, when the second extraction flag is turned on (needless to say, the first extraction flag is also turned on) the multimedia processor 10 compares the distance “D3” between the previous first target point and the current target point (Xc1, Yc1) with the distance “D4” between the previous first target point and the current target point (Xc2, Yc2), and the multimedia processor 10 sets the current first target point to the current target point (Xc1, Yc1) and the current second target point to the current target point (Xc2, Yc2) if the current target point (Xc1, Yc1) is nearer to the previous first target point, and sets the current second target point to the current target point (Xc1, Yc1) and the current first target point to the current target point (Xc2, Yc2) if the current target point (Xc2, Yc2) is nearer to the previous first target point. Meanwhile, if the distance “D3” is equal to the distance “D4”, the multimedia processor 10 sets the current first target point to the current target point (Xc1, Yc1) and the current second target point to the current target point (Xc2, Yc2).

Incidentally, when the second extraction flag is turned on, the current first target point may be determined in the same manner when only the first extraction flag is turned on as described above, and thereafter the second target point can be determined.

The process of FIG. 12 as described above is the process of detecting the retroreflective sheet 30L or 32L of the input device 3L and the retroreflective sheet 30R or 32R of the input device 3R.

Returning to FIG. 10, in step S4, the process of determining the input operation is performed.

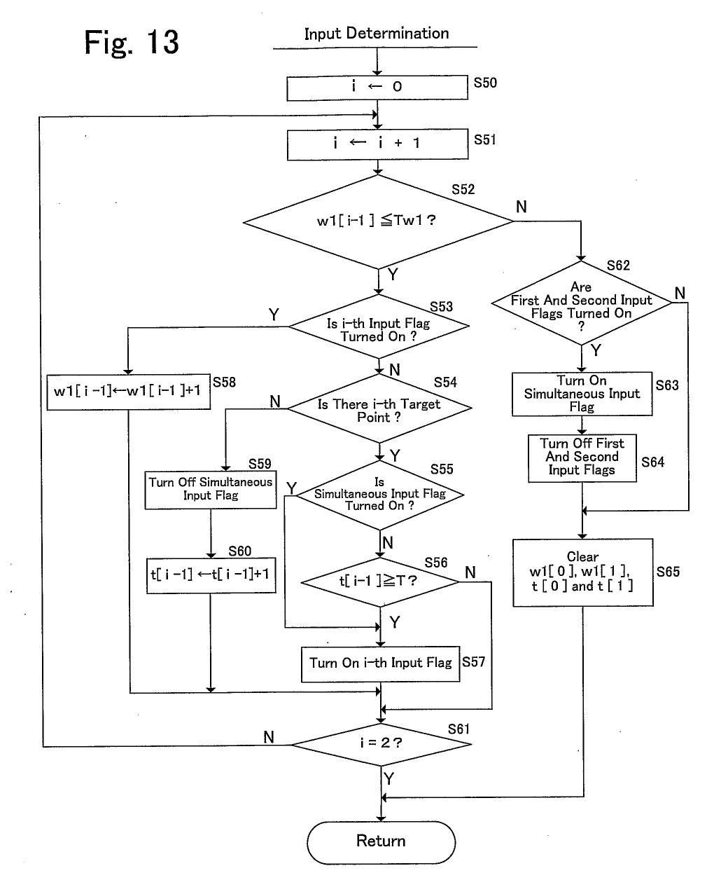

FIG. 13 is a flow chart showing an example of the process of determining the input operation in step S4 of FIG. 10. As in FIG. 13, in step S50, the multimedia processor 10 clears a counter value “i”. In step S51, the multimedia processor 10 increments the counter value “i” by one.

In step S52, the multimedia processor 10 determines whether or not the counter value w1[i−1] is less than or equal to a predetermined value “Tw1”, and if it is “Yes” the processing proceeds to step S53, conversely if it is “No” the processing proceeds to step S62. In step S53, the multimedia processor 10 determines whether or not an i-th input flag is turned on, and if it is “Yes” the processing proceeds to step S58, conversely if it is “No” the processing proceeds to step S54.

In step S54, the multimedia processor 10 determines whether or not there is the i-th target point, and if it is “Yes” the processing proceeds to step S55, conversely if it is “No” the processing proceeds to step S59.

In step S59, the multimedia processor 10 turns off a simultaneous input flag, and in the next step S60 the multimedia processor 10 increments the counter t[i−1] by one and proceeds to step S61.

After “Yes” is determined in step S54, the multimedia processor 10 determines whether or not the simultaneous input flag is turned on in step S55, and if it is “Yes” the processing proceeds to step S57, conversely if it is “No” the processing proceeds to step S56. In step S56, the multimedia processor 10 determines whether or not the counter value t[i−1] is greater than or equal to a predetermined value “T”, and if it is “No” the processing proceeds to step S61.

After “Yes” is determined in step S55 or “Yes” is determined in step S56, the multimedia processor 10 turns on the i-th input flag in step S57 and proceeds to step S61.

After “Yes” is determined in step S53, the multimedia processor 10 increments the counter value w1[i−1] by one in step S58 and proceeds to step S61.

Steps S51 to S61 are repeated until the counter value i=2 in step S61 or “No” is determined in step S52.

After “No” is determined in step S52, the multimedia processor 10 determines whether or not both the first and second input flags are turned on in step S62, and if it is “Yes” the processing proceeds to step S63, conversely if it is “No” the processing proceeds to step S65.

In step S63, the multimedia processor 10 turns on the simultaneous input flag. In step S64, the multimedia processor 10 turns off both the first and second input flag.

After step S64 or after “No” is determined in step S62, the multimedia processor 10 clears the counter values w1[0], w1[1], t[0] and t[1] in step S65, and returns to the main routine of FIG. 10.

In the process of FIG. 13 as described above, if the first target point is detected (step S54) after a predetermined or a longer period “T” (refer to step S56) in which the first target point is not detected, it is indicated by turning on the first input flag (step S57) that there is an input operation. The second target point is processed in the same manner.

However, if the first input flag and the second input flag are turned on at the same time or if one of the first input flag and the second input flag is turned on within the predetermined time “Tw1” (step S52) after the other input flag is turned on, the simultaneous input flag is turned on (step S63) in order to indicate that the input operations are performed with the input devices 3L and 3R at the same time. When the simultaneous input flag is turned on, the first and second input flags are turned off (step S64). In other words, a simultaneous both inputs operation is given priority to a one side input operation.

Returning to FIG. 10, in step S5, the multimedia processor 10 performs the process of determining a swing.

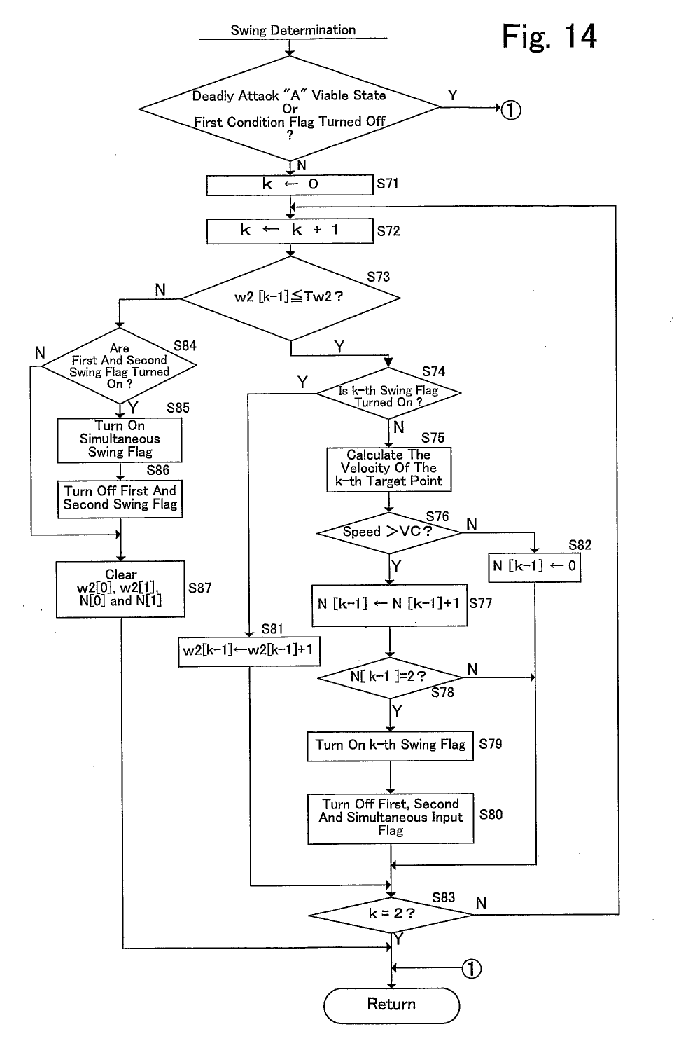

FIG. 14 is a flow chart showing an example of the process of determining a swing in step S5 of FIG. 10. As shown in FIG. 14, if it is determined in step S70 that it is in the state in which the deadly attack “A” can be wielded or that a first condition flag is turned off, the multimedia processor 10 skips steps S71 to S87 and returns to the main routine of FIG. 10, otherwise the multimedia processor 10 proceeds to step S71.

In step S71, the multimedia processor 10 clears a counter value “k”. In step S72, the multimedia processor 10 increments the counter value “k” by one.

In step S73, the multimedia processor 10 determines whether or not the counter value w2[k−1] is less than or equal to a predetermined value “Tw2”, and if it is “Yes” the processing proceeds to step S74, conversely if it is “No” the processing proceeds to step S84. In step S74, the multimedia processor 10 determines whether or not a k-th swing flag is turned on, and if it is “Yes” the processing proceeds to step S81, conversely if it is “No” the processing proceeds to step S75.

In step S75, the multimedia processor 10 calculates the velocity, i.e., the speed and direction of the k-th target point on the basis of the current and previous coordinates of the k-th target point. In this case, there are predetermined eight directions among which one direction is determined. In other words, 360 degrees are equally divided by eight to define eight angular ranges. The direction of the k-th target point is determined depending on which angular range the velocity (vector) of the k-th target point falls within.

In step S76, the multimedia processor 10 compares the speed of the k-th target point with a predetermined value “VC” in order to determine whether or not the speed of the k-th target point is greater, and if it is “Yes” the processing proceeds to step S77, conversely if it is “No” the processing proceeds to step S82, in which the counter value N[k−1] is cleared, and then proceeds to step S83.

In step S77, the multimedia processor 10 increments the counter value N[k−1] by one. In step S78, the multimedia processor 10 determines whether or not the counter value N[k−1] is “2”, and if it is “Yes” the processing proceeds to step S79, conversely if it is “No” the processing proceeds to step S83.

In step S79, the multimedia processor 10 turns on the k-th swing flag, and in the next step S80 the multimedia processor 10 turns off the simultaneous input flag, the first input flag, and the second input flag, and then proceeds to step S83.

After “Yes” is determined in step S74, the multimedia processor 10 increments the counter w2[k−1] by one in step S81 and proceeds to step S83.

Steps S72 to S83 are repeated until the counter value k=2 in step S83 or “No” is determined in step S73.

After “No” is determined in step S73, the multimedia processor 10 determines whether or not both the first and second swing flags are turned on in step S84, and if it is “Yes” the processing proceeds to step S85, conversely if it is “No” the processing proceeds to step S87.

In step S85, the multimedia processor 10 turns on the simultaneous swing flag. In step S86, the multimedia processor 10 turns off both the first and second swing flag.

After step S86 or after “No” is determined in step S84, the multimedia processor 10 clears the counter values w2[0], w2[1], N[0] and N[1] in step S87, and returns to the main routine of FIG. 10.

In the process of FIG. 14 as described above, the velocity of the first target point is calculated (step S75), and if the magnitude thereof (i.e., speed) is greater than the predetermined value “VC” in successive two cycles (step S78), the first swing flag is turned on to indicate that a swing is taken. The second target point is processed in the same manner.

However, if the first swing flag and the second swing flag are turned on at the same time or if one of the first swing flag and the second swing flag is turned on within the predetermined time “Tw2” (step S73) after the other swing flag is turned on, the simultaneous swing flag is turned on (step S85) in order to indicate that the swings are performed by the swing devices 3L and 3R at the same time.

When the simultaneous swing flag is turned on, the first and second swing flags are turned off (step S86). Incidentally, if at least one of the first input swing and the second swing flag are turned on, the simultaneous input flag, the first input flag and the second input flag are turned off (step S80). In other words, while the simultaneous input flag is given priority to the first input flag and the second input flag, a one side swing operation is given priority to these input flags, and a simultaneous both swings operation is given priority to a one side swing operation.

Returning to FIG. 10, in step S6, the right and left determination process for the first target point and the second target point is performed.

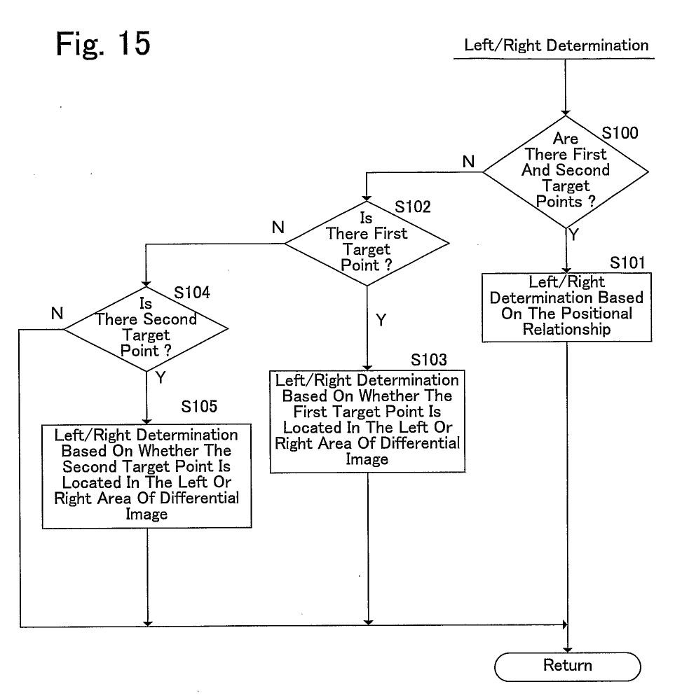

FIG. 15 is a flow chart showing an example of the right and left determination process in step S6 of FIG. 10. As shown in FIG. 15, in step S100, the multimedia processor 10 determines whether or not there are both the first target point and the second target point, and if it is “Yes” the processing proceeds to step S101, conversely if it is “No” the processing proceeds to step S102. In step S101, on the basis of the positional relationship between the first target point and the second target point, the multimedia processor 10 determines which is the left and which is the right, and returns to the main routine of FIG. 10.

After “No” is determined in step S100, the multimedia processor 10 determines whether or not there is the first target point in step S102, and if it is “Yes” the processing proceeds to step S103, conversely if it is “No” the processing proceeds to step S104. In step S103, if the coordinates of the first target point are located in the left area of the differential image obtained by the image sensor 12, the multimedia processor 10 determines that the first target point is the left, and if the coordinates of the first target point are located in the right area of the differential image, the multimedia processor 10 determines that the first target point is the right, and returns to the main routine of FIG. 10.

After “No” is determined in step S102, the multimedia processor 10 determines whether or not there is the second target point in step S104, and if it is “Yes” the processing proceeds to step S105, conversely if it is “No” the processing returns to the main routine of FIG. 10. In step S105, if the coordinates of the second target point are located in the left area of the differential image obtained by the image sensor 12, the multimedia processor 10 determines that the second target point is the left, and if the coordinates of the second target point are located in the right area of the differential image, the multimedia processor 10 determines that the second target point is the right, and returns to the main routine of FIG. 10.

Returning to FIG. 10, in step S7, the multimedia processor 10 sets the animation of an effect in accordance with the motion of the input device 3, i.e., the motion of the first and/or second target point.

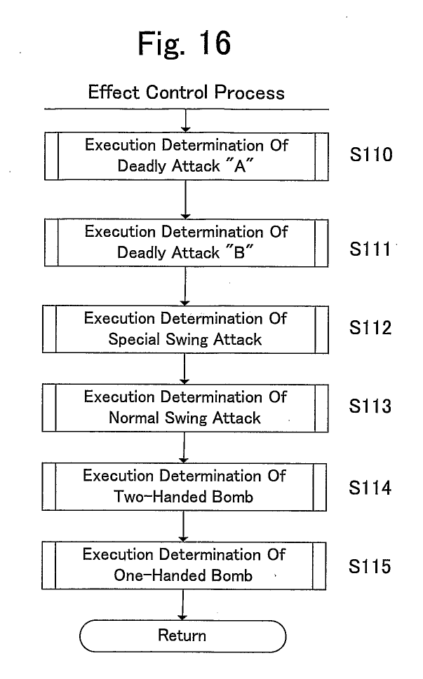

FIG. 16 is a flow chart showing an example of the effect control process in step S7 of FIG. 10. As shown in FIG. 16, in step S110, the multimedia processor 10 performs an execution determination process of the deadly attack “A” (refer to FIG. 6). However, as the condition for wielding the deadly attack “A”, an example differing from the above example is explained herein.

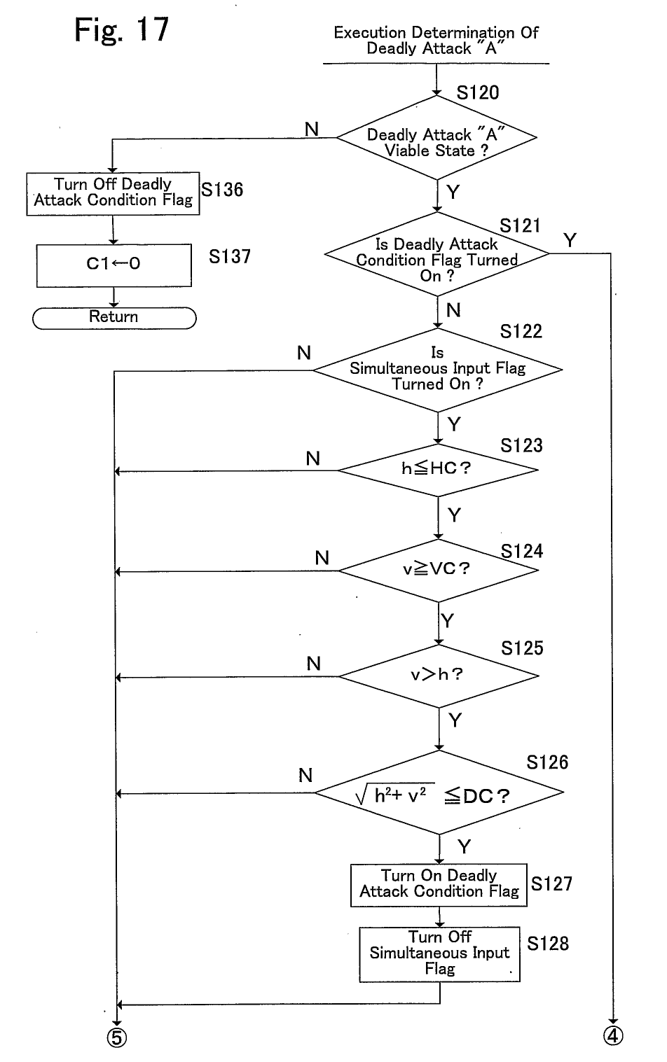

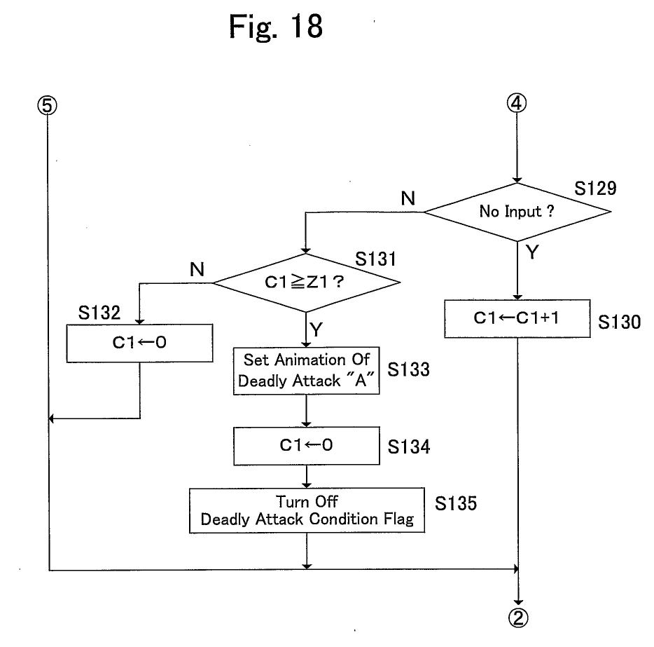

FIG. 17 and FIG. 18 are flow charts showing an example of the execution determination process of the deadly attack “A” in step S110 of FIG. 16. As shown in FIG. 17, in step S120, the multimedia processor 10 determines whether or not it is a state in which the deadly attack “A” can be wielded, and if it is “Yes” the processing proceeds to step S121, conversely if it is “No” the processing proceeds to step S136. In step S136, the multimedia processor 10 turns off a deadly attack condition flag, and clears the counter value C1 in step S137, and returns to the routine of FIG. 16.

After “Yes” is determined in step S120, the multimedia processor 10 determines whether or not the deadly attack condition flag is turned on in step S121, and if it is “Yes” the processing proceeds to step S129 of FIG. 18, conversely if it is “No” the processing proceeds to step S122.

In step S122, the multimedia processor 10 determines whether or not the simultaneous input flag is turned on, and if it is “Yes” the processing proceeds to step S123, conversely if it is “No” the processing proceeds to step S8 of FIG. 10.

In step S123, the multimedia processor 10 determines whether or not the horizontal distance (the distance in the X-axis direction) “h” between the first target point and the second target point is less than or equal to a predetermined value “HC”, and if it is “Yes” the processing proceeds to step S124, conversely if it is “No” the processing proceeds to step S8 of FIG. 10.

In step S124, the multimedia processor 10 determines whether or not the vertical distance (the distance in the Y-axis direction) “v” between the first target point and the second target point is greater than or equal to a predetermined value “VC”, and if it is “Yes” the processing proceeds to step S125, conversely if it is “No” the processing proceeds to step S8 of FIG. 10.

In this case, it is satisfied that HC>VC.

In step S125, the multimedia processor 10 determines whether or not the vertical distance “v” is greater than the horizontal distance “h”, and if it is “Yes” the processing proceeds to step S126, conversely if it is “No” the processing proceeds to step S8 of FIG. 10.

In step S126, the multimedia processor 10 calculates the distance between the first target point and the second target point and determines whether or not this distance is less than or equal to a predetermined value “DC”, and if it is “Yes” the processing proceeds to step S127, conversely if it is “No” the processing proceeds to step S8 of FIG. 10.

In step S127, the multimedia processor 10 turns on the deadly attack condition flag, and in step S128 the multimedia processor 10 turns off the simultaneous input flag and proceeds to step S8 of FIG. 10.

After “Yes” is determined in step S121, the multimedia processor 10 determines whether or not it is the no-input state, i.e., determines whether or not both the first and second target points do not exist in step S129 of FIG. 18, and if it is “Yes” the processing proceeds to step S130 in which a counter value C1 is incremented and the processing proceeds to step S8 of FIG. 10, conversely if it is “No” the processing proceeds to step S131.

In step S131, the multimedia processor 10 determines whether or not the counter value C1 is greater than or equal to a predetermined value “Z1”, and if it is “No” the processing proceeds to step S132 in which the counter value C1 is cleared and the processing proceeds to step S8 of FIG. 10, conversely if it is “Yes” the processing proceeds to step S133.

In step S133, the multimedia processor 10 sets, in the main RAM, image information (display coordinates, image storage location information and so forth) required for displaying the animation of the deadly attack “A”. In this case, the position in which the deadly attack “A” appears is determined in relation to the enemy character 50, and the display coordinates are determined in order to have the deadly attack A appear from this position.

The multimedia processor 10 clears the counter value C1 in step S134, turns off the deadly attack condition flag in step S135, and proceeds to step S8 of FIG. 10.

In the process of FIG. 17 and FIG. 18 as described above, on the assumption that the condition of step S120 is satisfied, the requirements for displaying the deadly attack “A” (step S133) are such that neither the first nor second target point is detected for a predetermined or a longer period “Z1” after the answers to all the decision blocks of steps S122 to S126 are “Yes” (i.e., after the deadly attack condition flag is turned on in step S127), and that thereafter at least one of the first and second target points is detected (steps S129 and S131). In this process, steps S122 to S126 are performed as a routine of detecting the state as illustrated in FIG. 3C, i.e., FIG. 8E.

Returning to FIG. 16, in step S111, the multimedia processor 10 performs the execution determination process of the deadly attack “B” (refer to FIG. 7). However, as the condition for wielding the deadly attack “B”, an example differing from the above example is explained herein.

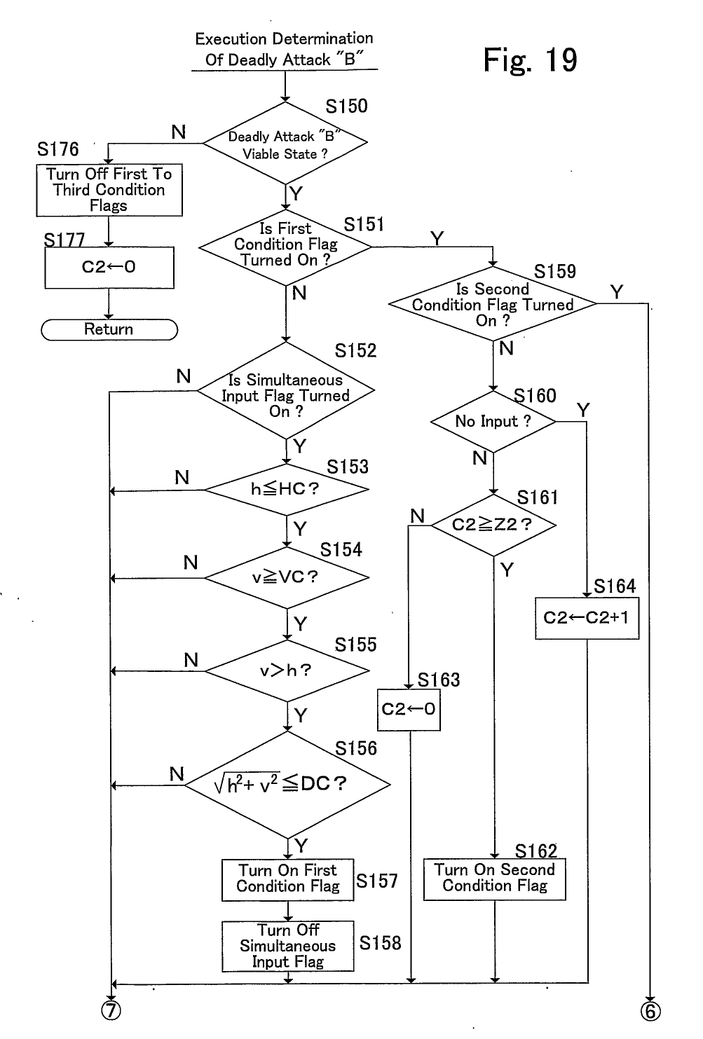

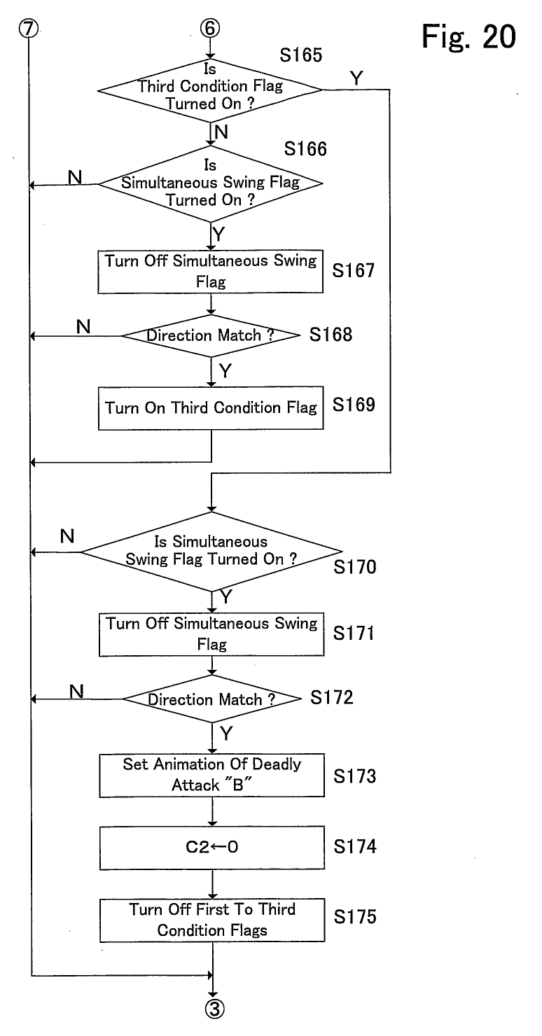

FIG. 19 and FIG. 20 are flow charts showing an example of the execution determination process of the deadly attack “B” in step S111 of FIG. 16. As shown in FIG. 19, in step S150, the multimedia processor 10 determines whether or not it is a state in which the deadly attack “B” can be wielded, and if it is “Yes” the processing proceeds to step S151, conversely if it is “No” the processing proceeds to step S176. In step S176, the multimedia processor 10 turns off first through third condition flags, and clears a counter value C2 in step S177, and returns to the routine of FIG. 16.

After “Yes” is determined in step S150, the multimedia processor 10 determines whether or not the first condition flag is turned on in step S151, and if it is “Yes” the processing proceeds to step S159, conversely if it is “No” the processing proceeds to step S152.

In step S152, the multimedia processor 10 determines whether or not the simultaneous input flag is turned on, and if it is “Yes” the processing proceeds to step S153, conversely if it is “No” the processing proceeds to step S8 of FIG. 10.

In step S153, the multimedia processor 10 determines whether or not the horizontal distance (the distance in the X-axis direction) “h” between the first target point and the second target point is less than or equal to the predetermined value “HC”, and if it is “Yes” the processing proceeds to step S154, conversely if it is “No” the processing proceeds to step S8 of FIG. 10.

In step S154, the multimedia processor 10 determines whether or not the vertical distance (the distance in the Y-axis direction) “v” between the first target point and the second target point is greater than or equal to the predetermined value “VC”, and if it is “Yes” the processing proceeds to step S155, conversely if it is “No” the processing proceeds to step S8 of FIG. 10.

In this case, it is satisfied that HC>VC.

In step S155, the multimedia processor 10 determines whether or not the vertical distance “v” is greater than the horizontal distance “h”, and if it is “Yes” the processing proceeds to step S156, conversely if it is “No” the processing proceeds to step S8 of FIG. 10.

In step S156, the multimedia processor 10 calculates the distance between the first target point and the second target point and determines whether or not this distance is less than or equal to the predetermined value “DC”, and if it is “Yes” the processing proceeds to step S157, conversely if it is “No” the processing proceeds to step S8 of FIG. 10.

In step S157, the multimedia processor 10 turns on the first condition flag, and in step S158 the multimedia processor 10 turns off the simultaneous input flag and proceeds to step S8 of FIG. 10.

After “Yes” is determined in step S151, the multimedia processor 10 determines whether or not the second condition flag is turned on in step S159, and if it is “Yes” the processing proceeds to step S165 of FIG. 20, conversely if it is “No” the processing proceeds to step S160. In step S160, the multimedia processor 10 determines whether or not it is the no-input state, i.e., determines whether or not both the first and second target points do not exist, and if it is “Yes” the processing proceeds to step S164 in which the counter value C2 is incremented and the processing proceeds to step S8 of FIG. 10, conversely if it is “No” the processing proceeds to step S161.

In step S161, the multimedia processor 10 determines whether or not the counter value C2 is greater than or equal to a predetermined value “Z2”, and if it is “No” the processing proceeds to step S163 in which the counter value C2 is cleared and the processing proceeds to step S8 of FIG. 10, conversely if it is “Yes” the processing proceeds to step S162. In step S162, the multimedia processor 10 turns on the second condition flag, and proceeds to step S8 of FIG. 10.

After “Yes” is determined in step S159, the multimedia processor 10 determines whether or not the third condition flag is turned on in step S165 of FIG. 20, and if it is “Yes” the processing proceeds to step S170, conversely if it is “No” the processing proceeds to step 166.

In step S166, the multimedia processor 10 determines whether or not the simultaneous swing flag is turned on, and if it is “Yes” the processing proceeds to step S167, conversely if it is “No” the processing proceeds to step S8 of FIG. 10.

In step S167, the multimedia processor 10 turns off the simultaneous swing flag, and proceeds to step S168. In step S168, if the velocities of the first target point and the second target point are oriented to the negative Y-axis, the multimedia processor 10 proceeds to step S169 otherwise proceeds to step S8 of FIG. 10. In step S169, the multimedia processor 10 turns on the third condition flag, and proceeds to step S8 of FIG. 10.

After “Yes” is determined in step S165, the multimedia processor 10 determines whether or not the simultaneous swing flag is turned on in step S170, and if it is “Yes” the processing proceeds to step S171, conversely if it is “No” the processing proceeds to step S8 of FIG. 10.

In step S171, the multimedia processor 10 turns off the simultaneous swing flag, and proceeds to step S172. In step S172 if the velocities of the first target point and the second target point are oriented to the positive Y-axis, the multimedia processor 10 proceeds to step S173 otherwise proceeds to step S8 of FIG. 10.

In step S173, the multimedia processor 10 sets, in the main RAM, image information (display coordinates, image storage location information and so forth) required for displaying the animation of the deadly attack “B”. The multimedia processor 10 clears the counter value C2 in step S174, turns off the first to third condition flags in step S175, and proceeds to step S8 of FIG. 10.

In the process of FIG. 19 and FIG. 20 as described above, on the assumption that the condition of step S150 is satisfied, the requirements for displaying the deadly attack “B” (step S173) are such that neither the first nor second target point is detected for a predetermined or a longer period “Z2” (step S161) after the answers to all the decision blocks of steps S152 to S156 are “Yes” (i.e., after the first condition flag is turned on in step S157), and that thereafter the answers to all the decision blocks of steps S166 and S168 are “Yes” (i.e., the third condition flag is turned on in step S169), and that the answers to all the decision blocks of steps S170 and S172 are “Yes”.

In this process, steps S152 to S156 are performed as a routine of detecting the state as illustrated in FIG. 3C, i.e., FIG. 8E. Steps S166 and S168 are performed as a routine of detecting the state as illustrated in FIG. 8H. Steps S170 and S173 are performed as a routine of detecting the state as illustrated in FIG. 8I.

Returning to FIG. 16, in step S112, the multimedia processor 10 performs an execution determination process of a special swing attack.

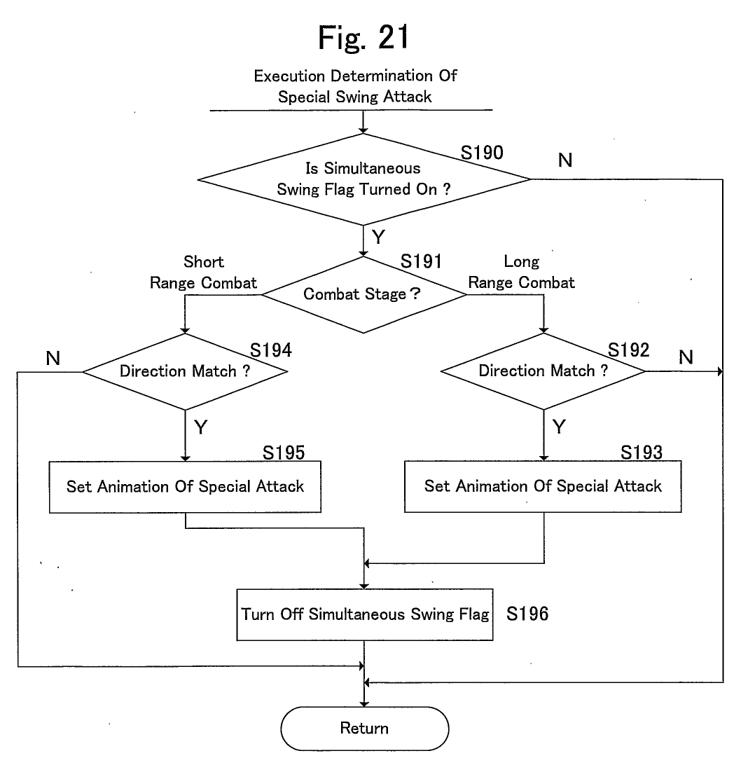

FIG. 21 is a flow chart showing an example of the execution determination process of the special swing attack in step S112 of FIG. 16. As shown in FIG. 21, in step S190, the multimedia processor 10 determines whether or not the simultaneous swing flag is turned on, and if it is “Yes” the processing proceeds to step S191, conversely if it is “No” the processing returns to the routine of FIG. 16.

In step S191, the multimedia processor 10 determines whether the combat stage is the long range combat or the short range combat, and if it is the long range combat the processing proceeds to step S192, conversely if it is the short range combat the processing proceeds to step S194.

In step S192, if the velocities of the first target point and the second target point are oriented to a predetermined direction “DF”, the multimedia processor 10 proceeds to step S193 otherwise returns to the routine of FIG. 16. In step S193, the multimedia processor 10 sets, in the main RAM, image information (display coordinates, image storage location information and so forth) required for displaying the animation of the special swing attack for the long range combat.

On the other hand, in step S194, if the velocities of the first target point and the second target point are oriented to a predetermined direction “DN”, the multimedia processor 10 proceeds to step S195 otherwise returns to the routine of FIG. 16. In step S195, the multimedia processor 10 sets, in the main RAM, image information (display coordinates, image storage location information and so forth) required for displaying the animation of the special swing attack for the short range combat.

In steps S193 and S195, the display coordinates are determined in order to display the special swing attack from a starting point at the coordinates calculated by averaging the X-coordinate of the first target point and the X-coordinate of the second target point, which are detected twice before, and converting the average coordinates into the screen coordinate system of the television monitor 5.

In step S196 after steps S193 and S195, the multimedia processor 10 turns off the simultaneous swing flag, and returns to the routine of FIG. 16.

The special swing attack appears in the television screen by the process of FIG. 21 as described above on the condition that swings with both hands are detected at the same time (step S190), and that the directions of the swings are the predetermined direction (DF or DN) (in steps S192 and S194).

Returning to FIG. 16, in step S113, the multimedia processor 10 performs the execution determination process of a normal swing attack.

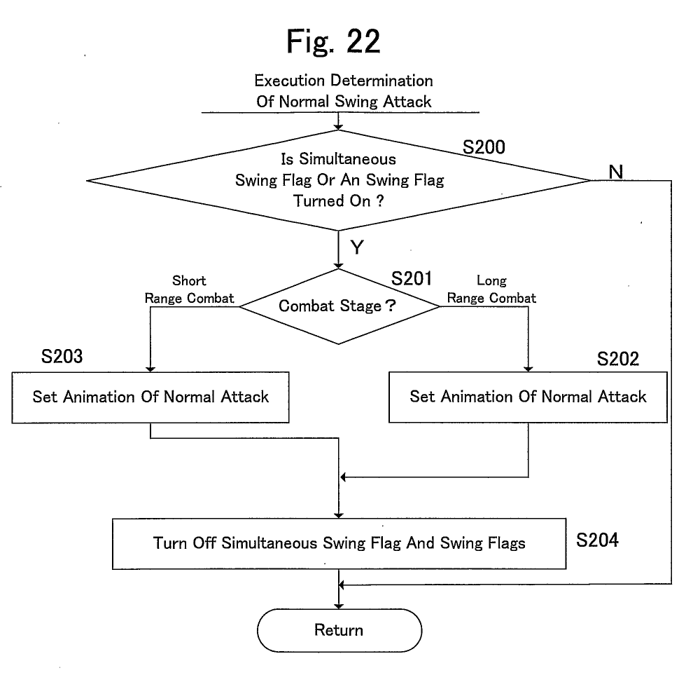

FIG. 22 is a flow chart showing an example of the execution determination process of the normal swing attack in step S113 of FIG. 16. As shown in FIG. 22, in step S200, the multimedia processor 10 determines whether or not any one of the simultaneous swing flag, the first swing flag and the second swing flag is turned on, and if it is “Yes” the processing proceeds to step S201, conversely if it is “No” the processing returns to the routine of FIG. 16.

In step S201, the multimedia processor 10 determines whether the combat stage is the long range combat or the short range combat, and if it is the long range combat the processing proceeds to step S202, conversely if it is the short range combat the processing proceeds to step S203.

In step S202, the multimedia processor 10 sets, in the main RAM, image information (display coordinates, image storage location information and so forth) required for displaying the animation of the normal swing attack for the long range combat. On the other hand, in step S203, the multimedia processor 10 sets, in the main RAM, image information (display coordinates, image storage location information and so forth) required for displaying the animation of the normal swing attack for the short range combat.

In step S204 after step S202 and S203, the multimedia processor 10 turns off the simultaneous swing flag, the first swing flag and the second swing flag, and returns to the routine of FIG. 16.

The normal swing attack appears in the television screen by the process of FIG. 22 as described above on the condition that swings with both hands are detected at the same time or a swing with one hand is detected (step S200).

For example, in the case of the short range combat, the hook punch image PC2 as described above is displayed as the normal swing attack. In this case, the display coordinates are determined in order to display the hook punch image PC2 moving in the direction of the swing from a starting point at the coordinates calculated by converting the coordinates of the first target point or the coordinates of the second target point which are detected twice before (in the case of simultaneous swings, the coordinates of the first target point detected twice before) corresponding to the swing as detected into the screen coordinate system of the television monitor 5.

For example, in the case of the long range combat, the shield object SL1 as described above is displayed as the normal swing attack. In this case, the display coordinates are determined in order to display the shield object SL1 moving in the direction of the swing from a starting point at the coordinates calculated by converting the coordinates of the first target point or the coordinates of the second target point which are detected twice before (in the case of simultaneous swings, the coordinates of the first target point detected twice before) corresponding to the swing as detected into the screen coordinate system of the television monitor 5.

Incidentally, as has been discussed above, since the direction of swing is determined as one of the eight directions, it is possible to display an animation moving in the direction of swing by assigning image information for the respective directions in advance and setting the image information corresponding to the direction of swing as detected in the main RAM.

Returning to FIG. 16, in step S114, the multimedia processor 10 performs the execution determination process of a two-handed bomb.

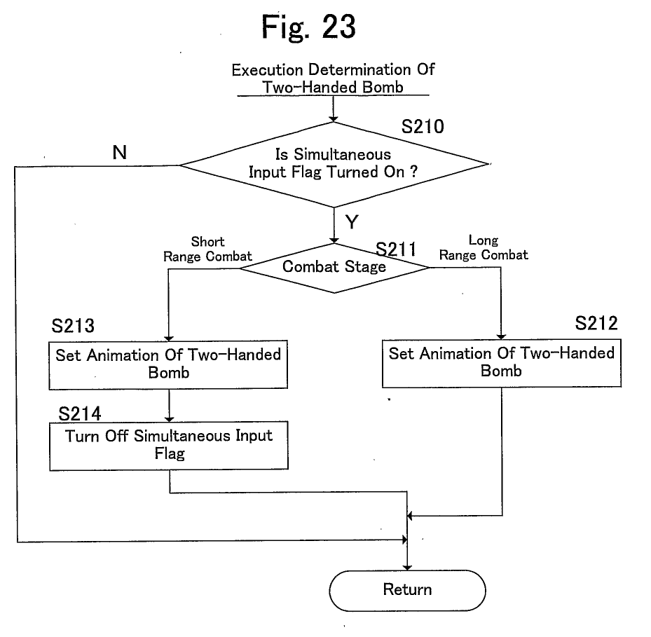

FIG. 23 is a flow chart showing an example of the execution determination process of the two-handed bomb in step S114 of FIG. 16. As shown in FIG. 23, in step S210, the multimedia processor 10 determines whether or not the simultaneous input flag is turned on, and if it is “Yes” the processing proceeds to step S211, conversely if it is “No” the processing returns to the routine of FIG. 16.

In step S211, the multimedia processor 10 determines whether the combat stage is the long range combat or the short range combat, and if it is the long range combat the processing proceeds to step S212, conversely if it is the short range combat the processing proceeds to step S213.

In step S212, the multimedia processor 10 sets, in the main RAM, image information (display coordinates, image storage location information and so forth) required for displaying the animation of the two-handed bomb for the long range combat, and returns to the routine of FIG. 16. On the other hand, in step S213, the multimedia processor 10 sets, in the main RAM, image information (display coordinates, image storage location information and so forth) required for displaying the animation of the two-handed bomb for the short range combat, and in step S214 the multimedia processor 10 turns off the simultaneous input flag, and returns to the routine of FIG. 16.

In steps S212 and S213, the display coordinates are determined in order to display the two-handed bomb image from a starting point at the coordinates calculated by averaging the coordinates of the first target point and the coordinates of the second target point, and converting the average coordinates in the screen coordinate system of the television monitor 5.

The two-handed bomb image appears in the television screen by the process of FIG. 23 as described above when the input operation with both hands is detected (in step S210). For example, in the case of the short range combat, the shield object SL2 as described above is displayed as the two-handed bomb image. For example, in the case of the long range combat, the attack object sh1 as described above is displayed as the two-handed bomb image.

Returning to FIG. 16, in step S115, the multimedia processor 10 performs the execution determination process of a one-handed bomb.

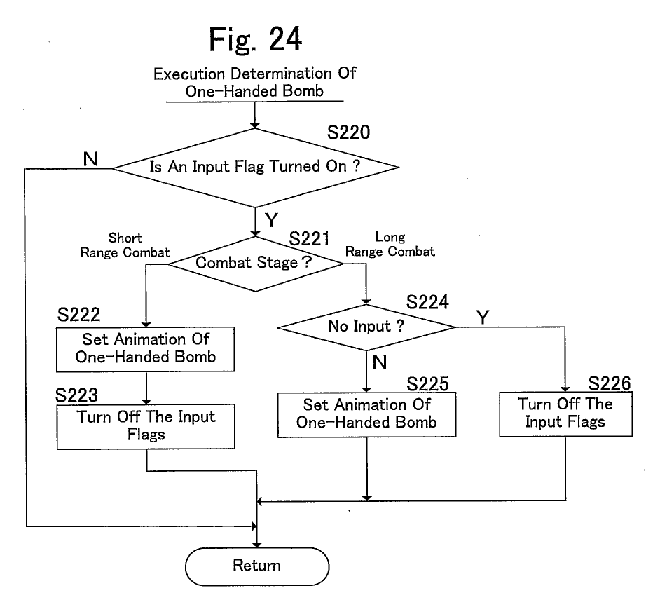

FIG. 24 is a flow chart showing an example of the execution determination process of the one-handed bomb in step S115 of FIG. 16. As shown in FIG. 24, in step S220, the multimedia processor 10 determines whether or not the first input flag or the second input flag is turned on, and if it is “Yes” the processing proceeds to step S221, conversely if it is “No” the processing returns to the routine of FIG. 16.

In step S221, the multimedia processor 10 determines whether the combat stage is the long range combat or the short range combat, and if it is the long range combat the processing proceeds to step S224, conversely if it is the short range combat the processing proceeds to step S222.

In step S224, the multimedia processor 10 determines whether or not it is the no-input state, i.e., determines whether or not both the first and second target points do not exist, and if it is “Yes” the processing proceeds to step S226 in which the first and second input flags is turned off and returns to the routine of FIG. 16, conversely if it is “No” the processing proceeds to step S225. In step S225, the multimedia processor 10 sets, in the main RAM, image information (display coordinates, image storage location information and so forth) required for displaying the animation of the one-handed bomb for the long range combat, and returns to the routine of FIG. 16.

On the other hand, in step S222, the multimedia processor 10 sets, in the main RAM, image information (display coordinates, image storage location information and so forth) required for displaying the animation of the one-handed bomb for the short range combat, and in step S223 the multimedia processor 10 turns off the first and second input flags, and returns to the routine of FIG. 16.

In steps S222 and S225, the display coordinates are determined in order to display the one-handed bomb image from a starting point at the coordinates calculated by converting the coordinates of the target point as detected of the first target point and the second target point into the screen coordinate system of the television monitor 5.

The one-handed bomb image appears in the television screen by the process of FIG. 24 as described above when the input operation with one hand is detected (in step S220). For example, in the case of the short range combat, the punch image PC1 as described above is displayed as the one-handed bomb image. For example, in the case of the long range combat, the bullet objects 64 as described above is displayed as the one-handed bomb image.

Returning to FIG. 10, in step S8, the multimedia processor 10 sets, in the main RAM, image information (display coordinates, image storage location information and so forth) required for displaying the animation of the enemy character 50 in accordance with the program in order to control the motion of the enemy character. In step S9, the multimedia processor 10 sets, in the main RAM, image information (display coordinates, image storage location information and so forth) required for displaying the animation of a background in accordance with the program in order to control the background.

In step S10, on the basis of the offense and defense of the enemy character 50 and the offense and defense of the player character, the multimedia processor 10 determines the attack hit of each character and sets, in the main RAM, image information (display coordinates, image storage location information and so forth) required for displaying the animation of the effect when the attack hits. In step S11, in accordance with the result of the hit determination in step S10, the multimedia processor 10 controls the physical energy gauges 52 and 56, the spiritual energy gauge 54, the hidden parameter and the offensive power parameters and controls the transition to the state in which the deadly attack “A” or “B” and the transition to the ordinal state.

The multimedia processor 10 repeats the same step S12, if “YES” is determined in step S12, i.e., while waiting for a video system synchronous interrupt (while there is no video system synchronous interrupt). Conversely, if “NO” is determined in step S12, i.e., if the CPU gets out of the state of waiting for a video system synchronous interrupt (if the CPU is given a video system synchronous interrupt), the process proceeds to step S13. In step S13, the multimedia processor 10 performs the process of updating the screen displayed on the television monitor 5 in accordance with the settings made in steps S7 to S11, and the process proceeds to step S2.

The sound process in step S14 is performed when an audio interrupt is issued for outputting music sounds, and other sound effects.

By the way, in accordance with the present embodiment as has been discussed above, the operator can easily perform the control of the input/no-input states detectable by the information processing apparatus 1 only by wearing the input device 3 and opening or closing a hand. In other words, the information processing apparatus 1 can determine an input operation when a hand is opened so that the image of the retroreflective sheet 32 is captured, and determine a non-input operation when a hand is closed so that the image of the retroreflective sheet 32 is not captured.

Also, in the case of the present embodiment, since the retroreflective sheet 32 is attached to the inner surface of the transparent member 44, the retroreflective sheet 32 does not come in direct contact with the hand of the operator so that the durability of the retroreflective sheet 32 can be improved.

Furthermore, in the case of the present embodiment, since the retroreflective sheet 30 is put on the back face of the fingers of the operator and oriented to face the operator, the image thereof is not captured unless the operator intentionally moves the retroreflective sheet 30 to make it face the information processing apparatus 1 (the image sensor 12). Accordingly, when the operator performs an input/no-input operation by the use of the retroreflective sheet 32, no image of the retroreflective sheet 30 is captured so that an incorrect input operation can be avoided.

Furthermore, in the case of the present embodiment, only by a simple structure, it is possible to enjoy experiences of extraordinary motions and phenomena, which cannot be experienced in the actual world, such as performed by the main character in an imaginary world such as a movie or an animation through the actions in the actual world (the operations of the input device 3) and through the images displayed on the television monitor 5 (for example, the images 64, 82 and 92 of FIG. 5 to FIG. 7).

Meanwhile, the present invention is not limited to the above embodiments, and a variety of variations and modifications may be effected without departing from the spirit and scope thereof, as described in the following exemplary modifications.

(1) The above explanation is provided for examples of the input operations to the information processing apparatus 1 performed with the input device 3 and the responses thereto performed by the information processing apparatus 1. However, the input operations and the responses are not limited thereto. It is possible to provide a variety of responses (displays) in correspondence with a variety of input operations and the combinations thereof.

(2) The transparent members 42 and 44 can be semi-transparent or colored-transparent.

(3) It is possible to attach the retroreflective sheet 32 to the surface of the transparent member 44 rather than the inside thereof. In this case, the transparent member 44 need not be transparent. Also, it is possible to attach the retroreflective sheet 30 to the inside surface of the transparent member 42. Incidentally, in the case where the retroreflective sheet 30 is attached to the surface of the transparent member 42 as described above, the transparent member 42 need not be transparent.

(4) While middle and annular fingers are inserted through the input device 3 in the structure as described above, the finger(s) to be inserted and the number of the finger(s) are not limited thereto, but for example it is possible to insert the middle finger alone.

(5) In the example as described above (refer to FIG. 13), as the condition of determining an input operation, it is set up that a state transition occurs from the state in which both the input devices 3L and 3R are not detected to the state in which one of the input devices 3L and 3R is detected or to the state in which both the input devices 3L and 3R are detected. However, it is possible to set up as the condition of determining an input operation that a state transition occurs from the state in which both the input devices 3L and 3R are detected to the state in which both the input devices 3L and 3R are not detected. For example, it is possible to set up as the condition of determining an input operation that the no-input state occurs after the state in which both the input devices 3L and 3R are detected is continued for a predetermined or a longer period. Also, it is possible to set up as the condition of determining an input operation that, after the state in which only one of the input devices 3L and 3R is detected is continued, both the input devices 3L and 3R comes not to be detected. For example, it is possible to set up as the condition of determining an input operation that the no-input state occurs after the state in which only one of the input devices 3L and 3R is detected is continued for a predetermined or a longer period.

(6) In the above description, both the transparent member 42 provided with the retroreflective sheet 30 and the transparent member 44 provided with the retroreflective sheet 32 are attached to the belt 40 of the input device. However, in order to form the input device, it is possible to attach only the transparent member 42 provided with the retroreflective sheet 30 to the belt 40 or only the transparent member 44 provided with the retroreflective sheet 32 to the belt 40.

(7) In the above description, the input device 3 is fastened to the hand by fitting the belt 40 onto fingers. However, the method of fastening the input device 3 is not limited thereto, but a variety of configurations can be thought for the same purpose. For example, in place of a belt worn on a finger(s), it is possible to use a belt configured for wearing it around the back and palm of a hand through the base of the little finger and through between the base of the thumb and the base of the index finger. In this case, the transparent member 42 and the transparent member 44 are attached respectively in a position near the center of the back of the hand and a position near the center of the palm. Also, in place of a belt, it is possible to make use of a glove such as a cycling glove together with a velcro fastener (Trademark) such that the attachment positions of the transparent member 42 and the transparent member 44 can be adjusted. In this case, it is possible to dispense with the transparent members 42 and 44 but attach the retroreflective sheets 30 and 32 directly to the glove. Also, needless to say, it is possible to dispense with the velcro fastener (Trademark) but fix the retroreflective sheets 30 and 32 to the glove in order that they cannot be detached therefrom. Furthermore, it is possible to use the input device 3 without a belt such that an operator directly holds the input device 3 in a hand and makes the retroreflective sheet 30 face the image sensor 12 at an appropriate timing. Still further, while the input device 3 is fastened to a hand by fitting the annular belt 40 onto fingers, it is also possible to use rubber strings which connects the transparent member 42 and the transparent member 44 such that the input device 3 is fastened to a hand by the use of these rubber strings.

(8) In the above description, the input device 3 is provided with the transparent member 42 and the transparent member 44 each of which is hollow inside in the form of a polyhedron. However, the structure of the input device 3 is not limited thereto, but a variety of configurations can be thought for the same purpose. For example, the transparent member 42 and the transparent member 44 can be formed in a round shape, such as the shape of an egg, rather than a polyhedron. Also, in place of the transparent member 42 and the transparent member 44, it is possible to use opaque members which may be round shaped or polyhedral shaped. In this case, the external surfaces thereof are covered with retroreflective sheets except for surface portions to be in contact with the back and palm of the hand.

While the present invention has been described in terms of embodiments, those skilled in the art will recognize that the invention is not limited to the embodiments described. The present invention can be practiced with modification and alteration within the spirit and scope of the appended claims. The description is thus to be regarded as illustrative instead of limiting in any way on the present invention.

1. An input device serving as a subject of imaging and operable to give an input to an information processing apparatus which performs a process in accordance with a program, comprising:
a first reflecting member operable to reflect light which is directed to the first reflecting member; and a wear member operable to be worn on a hand of an operator and attached to said first mount member.

2. The input device as claimed in claim 1 wherein said wear member is configured to allow an operator to wear it on a hand in order that said first reflecting member is located on the palm side of the hand.

3. The input device as claimed in claim 2 wherein said wear member is an bandlike member.

4. The input device as claimed in claim 2 wherein said first reflecting member is covered by a transparent member.

5. The input device as claimed in claim 1 wherein said wear member is configured to allow an operator to wear it on a hand in order that said first reflecting member is located on the back side of the operator's hand.

6. The input device as claimed in claim 5 wherein the reflecting surface of said first reflecting member is formed in order to face the operator when the operator wears said input device on the hand.

7. The input device as claimed in claim 5 wherein said wear member is an bandlike member.

8. The input device as claimed in claim 2 further comprising:
a second reflecting member operable to reflect light which is directed to said second reflecting member, wherein
said second reflecting member is attached to said wear member in order that said first reflecting member and said second reflecting member are oriented to opposite directions, wherein
said wear member is configured to allow the operator to wear it on a hand in order that said first reflecting member is located on the palm side of the hand and that said second reflecting member is located on the back side of the operator's hand.

9. The input device as claimed in claim 8 wherein the reflecting surface of said second reflecting member is formed in order to face the operator when the operator wears said input device on the hand.

10. The input device as claimed in claim 8 wherein said wear member is an bandlike member.

11. The input device as claimed in claim 4 further comprising:
a second reflecting member operable to reflect light which is directed to said second reflecting member,
said second reflecting member is attached to said wear member in order that said second reflecting member is opposed to said first reflecting member, wherein
said wear member is configured to allow the operator to wear it on a hand in order that said first reflecting member is located on the palm side of the hand and that said second reflecting member is located on the back side of the operator's hand.

12. The input device as claimed in claim 11 wherein the reflecting surface of said second reflecting member is formed in order to face the operator when the operator wears said input device on the hand.

13. A simulated experience method of detecting two operation articles to which motions are imparted respectively with the left and right hands of an operator and displaying a predetermined image on the display device on the basis of the detection result, said method comprising:
capturing an image of the operation articles provided with reflecting members; determining whether or not at least a first condition and a second condition are satisfied by the image which is obtained by the image capturing; and
displaying the predetermined image if the first condition and the second condition are satisfied at least, wherein
the first condition is that the image which is obtained by the image capturing includes neither of the two operation articles, wherein
the second condition is that the image obtained by the image capturing includes an image of at least one of the operation articles after the first condition is satisfied.

14. The simulated experience method as claimed in claim 13 wherein the second condition is that the image obtained by the image capturing includes both images of the two operation articles after the first condition is satisfied.

15. The simulated experience method as claimed in claim 14 wherein the second condition is that the image obtained by the image capturing includes the both images of the two operation articles in predetermined arrangement after the first condition is satisfied.

16. The simulated experience method as claimed in claim 13 wherein, in the step of displaying the predetermined image, the predetermined image is displayed when a third condition and a fourth condition are satisfied as well as the first condition and the second condition, wherein the third condition is that the image captured by the image capturing includes neither of the two operation articles after the second condition is satisfied, and wherein
the fourth condition is that the image captured by the image capturing includes at least one of the operation articles after the third condition is satisfied.

17. An entertainment system that makes it possible to enjoy simulated experience of performance of a character in an imaginary world, comprising:
a pair of operation articles to be worn on both hands of a operator when the operator is enjoying said entertainment system;
an imaging device operable to capture images of said operation articles;
a processor connected to said imaging device, and operable to receive the images of said operation articles from said imaging device and determine the positions of said operation articles on the basis of the images of said operation articles; and
a storing unit for storing a plurality of motion patterns which represent motions of said operation articles respectively corresponding to predetermined actions of the character, and action images which show phenomena caused by the predetermined actions of the character, wherein
when the operator wears said operation articles on the hands and performs one of the predetermined actions of the character, said processor determines which of the motion patterns corresponds to the predetermined action performed by the operator on the basis of the positions of said operation articles, and generates the video signal for displaying the action image corresponding to the motion pattern as determined.
